(19) United States
(12) Patent Application Publication
(10) Pub. No.: US 2003/0097404 A1
(43) Pub. Date: May 22, 2003

(54) Server apparatus, information processing device, control method of server apparatus, control method of information processing device, program component for server apparatus, and a program component for information processing device

(76) Inventors: Ken Sakakibara, Tokyo (JP); Yoshihisa Tadokoro, Tokyo (JP); Takashi Miyasaki, Kanagawa (JP); Naoko Hyotani, Kanagawa (JP)

Correspondence Address: ROBIN BLECKER & DALEY, 2ND FLOOR, 330 MADISON AVENUE, NEW YORK, NY, 10017, US

(21) Appl. No.: 10/290,382

(22) Filed: Nov. 7, 2002

(30) Foreign Application Priority Data
Nov. 16, 2001 (JP) 351498/2001
Dec. 12, 2001 (JP) 378590/2001
Oct. 24, 2002 (JP) 309808/2002

(51) Int. Cl. G06F 15/16

(52) U.S. Cl. 709/203

(57) ABSTRACT

With spreads of the Internet network, mobile communication networks, intranet networks within organizations, wireless LANs and other communication networks, there has been broadly prevailed a group information shared system in which user groups share their information with each other by utilizing those communication networks. A problem inherent in the group information shared system is that a user providing a useful piece of information to other users, a user participating in the group many times, a user logging in the group for a long time, are not displayed in conspicuous positions. Such being the case, according to the invention of the present application, order processing is executed based on information such as a receipt count etc of message information, wherein the user providing the useful information to other users is displayed in a visually-easy-to-recognize position. The order processing can be executed from only a specified terminal, whereby all the users can browse the message information in the same layout.

### BACKGROUND OF THE INVENTION

1. Field of the Invention

The present invention relates generally to a server apparatus, an information processing device, methods thereof, and programs thereof, and more particularly to a server apparatus, an information processing device, methods thereof, and programs thereof in a group information shared system enabling a plurality of users to share information on general categories of messages such as user-written affairs-related messages, schedule-related messages and other messages.

2. Related Background Art

With spreads of the Internet network, mobile communication networks, intranet networks within organizations, wireless LANs and other communication networks, there has been broadly prevailed a group information shared system in which user groups share their information with each other by utilizing those communication networks. Specific examples thereof are an instant messaging application, a groupware system, a text chat application etc that will hereinafter be explained.

### CONVENTIONAL EXAMPLE 1

Instant Messaging Application

The instant messaging (IM) application is an application that allows mainly friends and family members to exchange short messages therebetween and to share the information with each other. Occasionally, these applications may be called such as [Pager], [Instant Messenger] and so on. Further, the usefulness of the instant messaging application has been broadly recognized over the recent years. This recognition leads in some cases to a standard installation of the same function as the instant messaging application into OS (Operating System) for personal computers. The use of these instant essaging applications enables the users to communicate with each other in a variety of modes by use of the message information and to know whether or not other users connect to (or log-in) the communication network such as the Internet etc at the present. Thus, the instant messaging application might be able to obviate a sense of isolation of the individual even if apart from the friends and family members, and further to perform smoother mutual communications than by phone etc, with the result that the same application helps keep and strengthen interconnections to the friends and family members.

### CONVENTIONAL EXAMPLE 2

Groupware

The groupware system is a system in which office workers in an organization chiefly like an enterprise share the information with each other by exchanging messages, schedules and so forth. The use of this groupware system enables the users to communicate with each other mainly for business purposes involving the user of a messaging function, a schedule information sharing function etc, thus yielding an effect that the business communications can be quickly performed and so on, even when the users stay scattered in remote places or there is a less opportunity of meeting each other due to their different working hours.

The instant messaging application and the groupware system exemplified in the conventional examples given above, however, have the following problems.

The description is at first focused on the problem inherent in the instant messaging application exemplified in the conventional example 1.

FIG. 1 shows one example of a display screen of the instant messaging application. As shown on this display screen, the user registers by himself or herself a group (that consists of friends (company), friends (high school) and a soccer group in FIG. 1). Further, the users belonging to the group are registered from on a user interface of the instant messaging application used by the user himself or herself, wherein pieces of information showing whether or not other users connect to the Internet and are in a possible-of-messaging state with the user himself or herself, can be recognized from differences in configuration and color (such as a smile mark etc in the example in FIG. 1).

Moreover, the users can share messages (which involves a case of selecting those from among cliche messages initially contained in the application, and a case where the user inputs a freestyle sentence) such as [day-off], [busy now], [leaving seat], [at table], [go home] commented sideways of the user names (this example is shown in FIG. 14). Further, this function includes such immediateness that if the message is changed, the changed content immediately reflects in the same application of other users. With this function, if the instant messaging application is used for the message communications between the groups, it can be judged at once who is the user able to participate in a chat at the present (the chat herein implies sending and receiving the messages, and it is also possible to share the message of the user himself or herself who is [busy now] etc with other users.

In the case of the present conventional example, however, the operation of registering the groups and the users is all handled by a user's registration operation in the instant messaging application. Accordingly, the user additionally registers a new group or new other users each time there increase persons using the same application among the friends and family members. As a result of this, however, it follows that the users displayed in upper positions are only those having the communications in a period far back in the past but little communications at the present, while the users displayed in lower positions are only those as recent acquaintances having active communications. Therefore, the information about the users as the recent acquaintances having the active communications has higher importance to the user concerned. Nevertheless, only the names of the users having the communications in the period far back in the past but little communications of late, are still displayed in the upper positions on the screen of the personal computer utilized by the user concerned, and a problem is therefore that a display space thereof is futile.

The user can delete the upper-displayed users having the communications in the period far back in the past from a display list by the user's operation. The change operation of deleting them is, however, considerably complicated, and hence a problem is that the user is reluctant to do so. Another problem arises, wherein once those names are deleted, none of the information of the deleted users is displayed from now onwards, and the user concerned refuses it and does not dare to delete (in the expectation that the communications with delete target users might get active again), with the result that the futile area of the display space increasingly becomes large with an increased number of the users as the other parties and the display area on the display of the personal computer of the user is wastefully used. These problems will be pointed out as more serious problems from now into the future as there increases the number of the users utilizing the personal computers into which the OS containing the instant messaging application is preinstalled.

According to the groupware system exemplified in the conventional example 2, the scheme is not that the user registers other users as in the conventional example 1, but that the administrator of the groupware system registers the users participating in the group, whereby the all the group members can see the user information of the users arranged in the same order. In this case, the administrator of the server apparatus determines and changes the user display order, whereby the individual users can permute the user display order displayed in a way that eliminates such a burden that each user performs a registration change operation.

Since the administrator of the groupware system sets the order, however, it is known that the display order inevitably becomes stereotyped. For instance, in the case of a group of friends, the order is: the person as a kind of leader of this group; the person as a kind of sub-leader; and other members.

In the case of a group of family members, the order is:

grand parents;

parents; and

children.

Further, in the case of being used for affairs in an organization such as an enterprise, it is general that the order is set according to a ranking system of posts etc, their ages and entrance years.

In the actual utilization, however, it is known that the users (the users as the leaders, the ground parents etc) positioned in upper ranks of these orders usually have a less opportunity of using the groupware system

While on the other hand, it is known that some of the persons positioned in lower ranks of those orders get a good popularity from other users because of their being ample of topics, have a well-nurtured humanity and a capability of writing a message containing a less number of characters but impressing others, and have a meticulous nature and a versatility enough to help other users by frequently doing log-in and writing the messages. Thus, a problem is that the users sending the messages necessary for other users and are nevertheless displayed in the lower display area.

As described above, according to the group information shared system including the conventional instant messaging application, the conventional groupware system etc, the messages related to the users that the user concerned desires to focus on most, are displayed often in the lower positions of the entire display area, with the result that an upper display space becomes futile. Further, the lower space turns out to be outside the display area of the window system, wherein other users are not aware of where the messages sent with efforts exist, or the users positively chatting are positioned lower in the order as ever before and might be, as a result, invisible to other users out of the window display of the user. The problem is therefore that the user's enthusiasm about chatting might be lost. Hence, even when the variety of conventional techniques are introduced, the situation is far from efficiently accomplishing a purpose that the group users positively share various categories of messages including communications of affairs and informal communications in order to activate group activities.

### CONVENTIONAL EXAMPLE 3

Text Chat Application

As a conventional text chat application is popular, its description is omitted.

There further arise the following problems peculiar to the text chat application.

On the terminal device installed with the conventional text chat application, a character string showing who is the speaker, a character string of message as a content of the chat, a character string for notifying other uses that the user starts using the application, and a character string notifying other users that the user finishes using the application, are sequentially displayed in time-series on the display screen. This type of display screen has a problem, wherein a user (especially a user participating midways afresh in a conversation text chat is unable to promptly distinguish who is the user participating in the chat at the present). Another problem is that if somebody gives a query, other person is actually pressed by a necessity of replying immediately and receives a question of such a nature as to be embarrassed to answer, and the atmosphere becomes awkward unless some reply is made even in such a case. A further problem is that normally the topic of the conversation is limited to one category, the user requested to chat along this line can make neither a chart at a free timing nor a proposal of easily changing the present topic to a different topic. A still further problem is that particularly a soliloquy and a worry that do not necessarily need receiving replies from other persons can not in fact sent as messages, and therefore the conventional system is hard to utilize as a means of informal communications.

Problems of instant messaging applications will be described hereinafter.

1. In the majority of instant messaging applications, operations of naming the groups displayed on the screen, determining the order of displaying the plurality of groups, setting display positions of the messages of the users belonging to the group and determining which user belongs and which group the user belong to, are all handled by each user using the instant messaging application. Therefore, a disadvantage is that the operations are complicated to the general users.

2. Further, when the plurality of users perform the message communications by utilizing the same instant messaging application, there is also a disadvantage in which the user message display position displayed on the display screen differs on every user screen.

3. A still further disadvantage is that the way of setting who is the other party of the message communications and who is ruled out of a category of the other party thereof, differs depending on every user.

As described above, in the case where the instant messaging application is utilized by the group members such as co-workers in a working place, the relatives and the family members who are more or less fixed as the group forming members, there exists a problem in which the conventional instant messaging application is improper.

The following is the description in greater detail.

1. A first problem is that a registration of other users, it is required, be done by the user himself or herself, and this operation is much laborious. To give an example, supposing that ten users as the family members and the relatives perform the communications by utilizing the instant messaging application, a certain user needs to register other nine users by use of an user interface of the instant messaging application running on the user's own personal computer. The operation of registering other users in the instant messaging application of the user himself or herself generally involves means such as inputting, if informed of, user Ids of other users, or transmitting, if informed of only mail addresses, these pieces of mail address information of other users to a server of a service provider for providing the connection service for the instant messaging application, then receiving in turn information about the user IDs, and registering other users by use of these user IDs. It is, however, known that this operation is complicated. Further, the same operation must be executed for all the nine users as the other parties, and this intricacy has hitherto been the biggest factor for hesitating the users to utilize the instant messaging application used for the communications between the groups.

2. A second problem is that the respective user message display positions displayed on the user screens differ on every user screen. This problem will be explained. For example, a user A sends a message such as [I wonder if a typhoon will come today], and a user B tries to reply a message such as [It couldn't be]. In this case, if a message display position of the user B exists under a message display position of the user A on the screens of all the users, the user B simply inputs a message (symbol) of an arrowhead (↑) implying [↑ It couldn't be], and the meaning is understandable. In fact, however, the users A and B are not necessarily be set as the other parties for the communications on the screens of the individual users. Further, the message display positions of the users A and B are not fixed, wherein the message of the user B does not necessarily come under the message display position of the user A. Hence, there is a possibility in which the message as sent by the user B does not convey whom this message is replied to, to other persons.

3. A third problem is that the way of setting who is the other party for the message communications and who is ruled out of the category of the communications, might differ according to every user. In the conventional instant messaging application, if a user C registers users D and E in the instant message application of the user C himself or herself, neither user D nor the user E is in the message-communicable state with each other. Accordingly, if the user D conveys a certain bit of information to the user C, the user C does not recognize respective conditions about the registrations in their instant messaging applications, and is therefore unable to know whether the information received from the user D is likewise transmitted to the user E. Consequently, there arises a problem of being incompatible in terms of sharing the information within the group, i.e., a problem about keeping the compatibility of the message communications within the group.

To obviate this problem, the following method may be adopted in some cases if the instant messaging application is utilized as a group communication tool. To be specific, what is taken as an operation method is that the user appointed as a leader of the group initially all determines naming the group and the group members, then notifies the respective users of these items, and the respective users start using the too in accordance with that notice. A display mode on the screens of the users can be thereby set common. If the members are added and changed for the duration of utilizing the tool thereafter, however, according to the conventional instant messaging application, the members can be registered or deleted, and the message display positions (order) can be permuted by the user's operation as the user intends, and hence a problem is caused, wherein the display modes on the screens of the respective users become different from each other little by little.

As explained above, the conventional message communication system is not so configured as to respond the needs wherein the group members exhibiting high fixedness of the membership desire to easily simply share the messages with the immediateness.

Accordingly, it is an object of the present invention, which was devised in view of the problems given above, to provide a technology capable of displaying a display screen configured in the same user order on the display screens of all the group members, reflecting, if the member is changed, this change on the screen displays of all the members simply by a change operation of a system administrator, and preventing the general users from manipulations about selecting the users and changing the order on the display screen.

### SUMMARY OF THE INVENTION

To accomplish the above object, according to one aspect of the present invention, a server apparatus connected via communication lines to information processing devices having display unit and controlling a transmission and a receipt of the information between the information processing devices, includes a receiving unit for receiving the information from the information processing device, a layout information creating unit for creating display layout information, to be displayed on the display unit, of an identifier for identifying each of the information processing devices and the information corresponding to the identifier, a first transmitting unit for transmitting the information to each of the information processing devices, and a second transmitting unit for transmitting the layout information to each of the information processing devices.

According to another aspect of the present invention, an information processing device connected via a communication line to a server apparatus and transmitting and receiving information to and from other information processing devices via the server apparatus, includes a first receiving unit for receiving the information transmitted from the server apparatus, a second receiving unit for receiving layout information transmitted from the server apparatus, and a display unit for displaying an identifier for identifying each of the information processing devices and the information corresponding to each of the information processing devices, wherein display positions of the identifier and the information displayed by the display unit are controlled by the layout information.

According to still another aspect of the present invention, a control method of a server apparatus connected via communication lines to information processing devices having display unit and controlling a transmission and a receipt of the information between the information processing devices, includes a receiving step of receiving the information from the information processing device, a layout information creating step of creating display layout information, to be displayed on the display unit, of an identifier for identifying each of the information processing devices and the information corresponding to the identifier, a first transmitting step of transmitting the information to each of the information processing devices, and a second transmitting step of transmitting the layout information to each of the information processing devices.

According to yet another aspect of the present invention, a control method of an information processing device connected via a communication line to a server apparatus and transmitting and receiving information to and from other information processing devices via the server apparatus, includes a first receiving step of receiving the information transmitted from the server apparatus, a second receiving step of receiving layout information transmitted from the server apparatus, and a display step of displaying an identifier for identifying each of the information processing devices and the information corresponding to each of the information processing devices, wherein display positions of the identifier and the information displayed by the display unit are controlled by the layout information.

According to a further aspect of the present invention, a program component for a server apparatus connected via communication lines to information processing devices having display unit and controlling a transmission and a receipt of the information between the information processing devices, includes a program code of receiving the information from the information processing device, a program code of creating display layout information, to be displayed on the display unit, of an identifier for identifying each of the information processing devices and the information corresponding to the identifier, a program code of transmitting the information to each of the information processing devices, and a program code of transmitting the layout information to each of the information processing devices.

According to a still further aspect of the present invention, a program component for an information processing device connected via a communication line to a server apparatus and transmitting and receiving information to and from other information processing devices via the server apparatus, includes a program code of receiving the information transmitted from the server apparatus, a program code of receiving layout information transmitted from the server apparatus, and a program code of displaying an identifier for identifying each of the information processing devices and the information corresponding to each of the information processing devices, wherein display positions of the identifier and the information displayed by the display unit are controlled by the layout information.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention, in which:

FIG. 1 is a view showing one example of a display screen of an instant messaging application;

FIG. 2 is a view showing a system architecture of a whole group information shared system according to the invention of the present application;

FIG. 3 is a view showing an example of an initial display screen when starting the operation in an embodiment of the present invention;

FIG. 4 is a block diagram showing a configuration of a terminal device;

FIG. 5 is a block diagram showing a configuration of a server apparatus;

FIG. 6 is an explanatory flowchart showing an operation of the terminal device in a first embodiment;

FIG. 7 is an explanatory flowchart showing an operation of the server apparatus in the first embodiment;

FIG. 8 is a view showing a screen for prompting a user to input a user ID and a password;

FIG. 9 is a view showing an example of a screen for inputting message information;

FIG. 10 is a chart showing an example of the message information stored on a message information database;

FIG. 11 is a view showing a display example of being displayed on the screen of the terminal device in accordance with the screen layout information based on a new set of order information in the first embodiment;

FIG. 12 is an explanatory flowchart showing an operation of the server apparatus in a second embodiment;

FIG. 13 is a view showing an example of a screen for inputting image information;

FIG. 14 is a view showing how a selectable message is displayed based on the instant messaging application;

FIG. 15 is a view showing a system architecture of the whole group information shared system in an eighth embodiment;

FIG. 16 is an explanatory flowchart showing an operation of the server apparatus in the eighth embodiment;

FIG. 17 is a block diagram showing a configuration of a result management system apparatus 204 in the eighth embodiment;

FIG. 18 is a view showing a system architecture of a message shared system in an eleventh embodiment of the present invention;

FIG. 19 is a view showing one example of a screen displayed on a display of the user terminal device when operating the message shared system;

FIG. 20 is a block diagram showing configurations of the user terminal device and of a system administrator terminal device;

FIG. 21 is a block diagram showing an internal configuration of the server apparatus;

FIG. 22 is a flowchart showing operating steps of the user terminal device;

FIG. 23 is a flowchart showing operating steps of the server apparatus;

FIG. 24 is a flowchart showing operating steps of the terminal device in a twelfth embodiment;

FIG. 25 is a flowchart showing operating steps of the server apparatus in the twelfth embodiment;

FIG. 26 is a flowchart showing operating steps of the system administrator terminal device;

FIG. 27 is a view showing a screen displayed on a display unit 44 of the system administrator terminal device immediately after booting a system administrator program;

FIG. 28 is a view showing a screen displayed on the display unit 44 of the system administrator terminal device immediately before registering and changing company information;

FIG. 29 is a view showing a screen displayed on the display unit 44 of the system administrator terminal device immediately before registering and changing office information;

FIG. 30 is a view showing a screen displayed on the display unit 44 of the system administrator terminal device immediately before registering and changing user information; and

FIG. 31 is a view showing a screen display example of [Yahoo! Messenger].

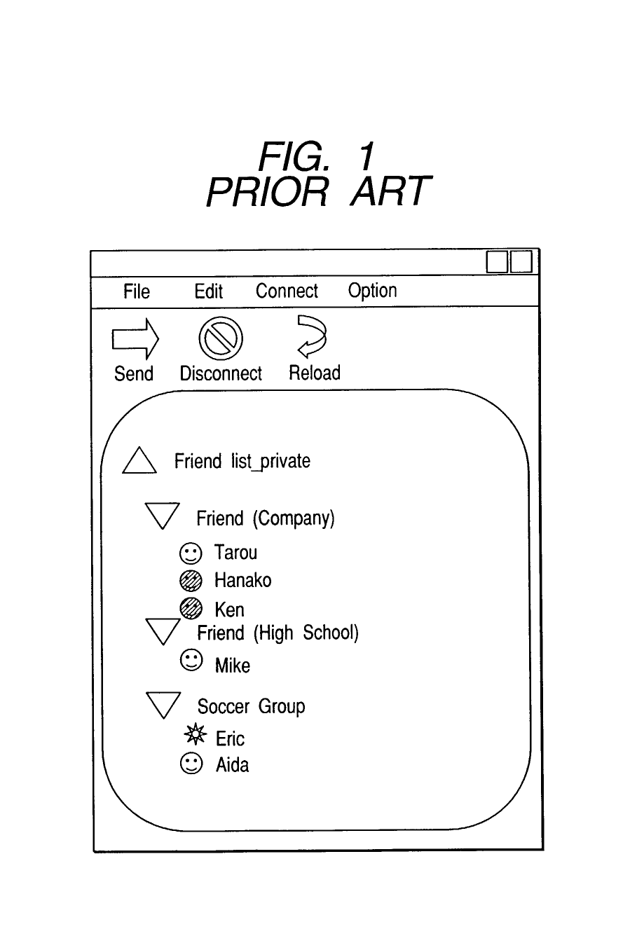

### DETAILED DESCRIPTION OF THE PREFERRED EMBODIMENTS

Preferred embodiments of the present invention will hereinafter be described in detail with reference to the accompanying drawings.

[First Embodiment]

(Generation of Layout Based on Message Receipt Count)

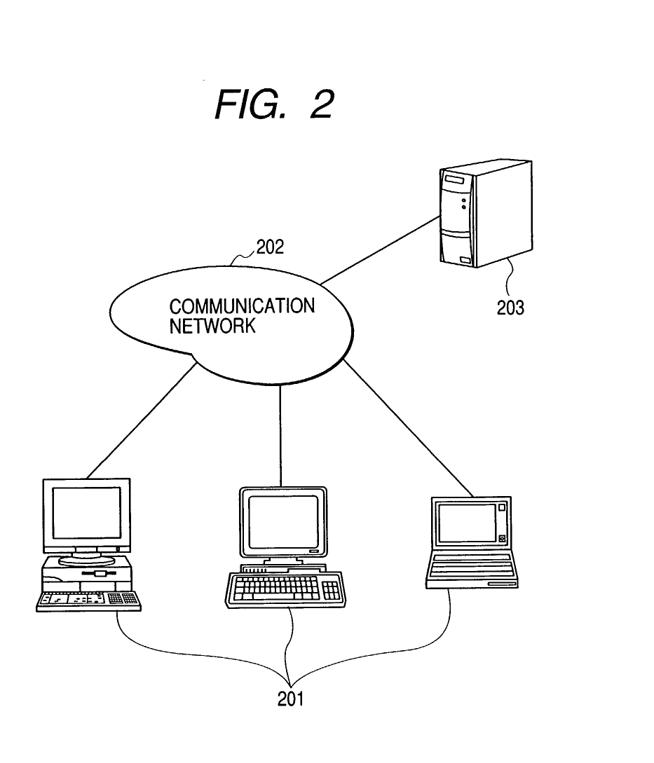

FIG. 2 shows a system architecture of a whole group information shared system according to the invention of the present application.

Referring to FIG. 2, the numeral 201 represents a terminal device incorporating a communication function and connected to a communication network 202 such as the Internet, LAN and so on. Note that the terminal device 201 is categorized as a personal computer, a mobile terminal such as a PDA (Personal Digital Assistant), and so forth, and operates based on program data for the group information shared system terminal device. The terminal device 201 generally includes a keyboard and a pointing device (such as a mouse, a trackball etc) as input devices, and some of the terminal devices include video cameras as input devices. The numeral 203 designates a server apparatus incorporating the communication function and is connected to the Internet 202 as in the case of the terminal device 201. Note that the server apparatus 203 is categorized as a computer etc for a server and operates based of the program data for the group information shared system service device.

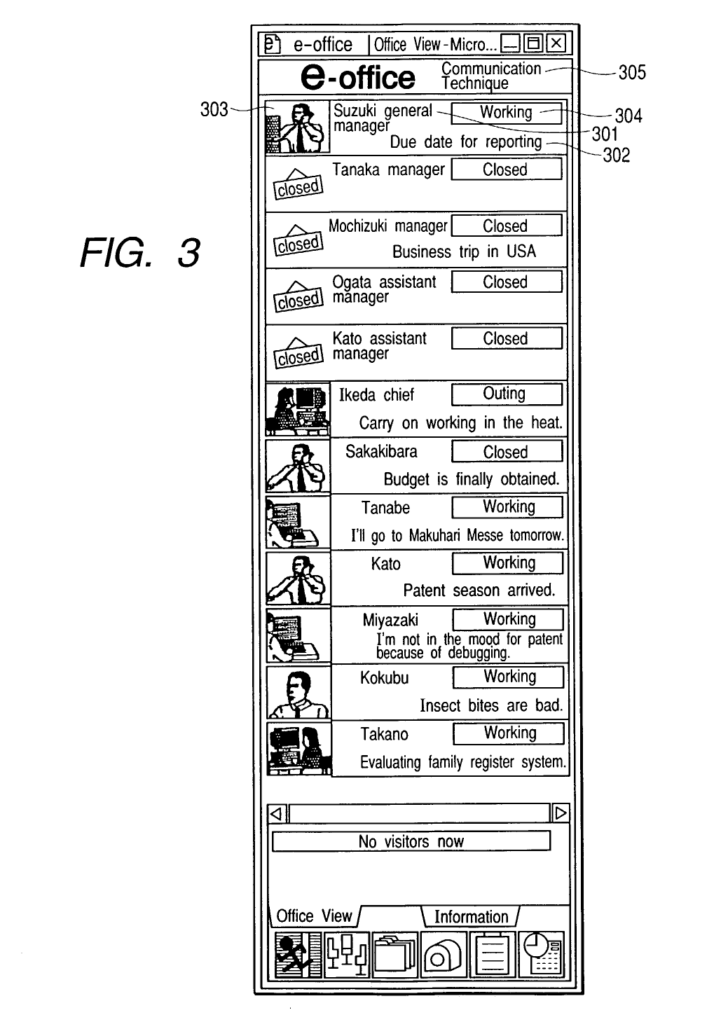

FIG. 3 shows an example on a screen display appearing on the display screen of the terminal device 201 just at the start of the operation of the group information shared system in the first embodiment.

Referring to FIG. 3, there are displayed a user name (identifier) 301, a piece of message information 302 defined as character information transmitted by the user concerned, and a piece of message information 303 defined as image information transmitted by the user concerned.

The image message information 303 is subcategorized into a piece of image information stored on the terminal device 201 of the user concerned and into an image captured recently on the video camera in the case of providing the terminal device 201 with the video camera as the input device. A piece of message information 304 is symbolic information sent by the user concerned. The message information is not, as a matter of course, limited to the character information as indicated by 302, the image information as indicated by 303 and the symbolic information as indicated by 304.

The numeral 305 denotes a name of the group to which the user belongs, and FIG. 3 shows how the group information shared system is utilized, wherein 12 users are registered in an [e-office communication technique] group 305. Note that the screen display example illustrated in FIG. 3 is displayed on all the users' terminal devices.

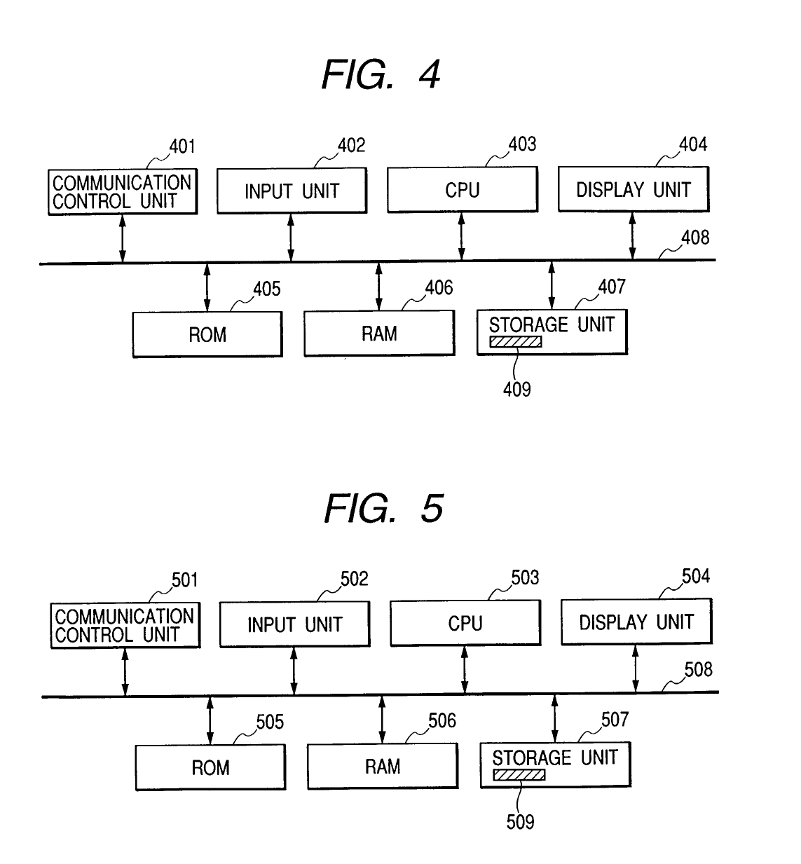

FIG. 4 is a block diagram showing a configuration of the terminal device 201 in the first embodiment.

Referring to FIG. 4, there are shown a communication control unit 401, an input unit 402, a CPU 403, a display unit 404, a ROM (Read Only Memory) 405, a RAM (Random Access Memory) 406, a storage unit 407 and a system bus 408.

The communication control unit 401 executes communication control for establishing connections to the communication network 202 such as the Internet etc, however, various categories of communication interfaces are applied corresponding to platforms (environments) utilized by the users. For example, the communication control unit 401 is constructed of various types of modems and terminal adapters in the case of being connected directly to the communication network 202, and is also constructed of an Ethernet interface in the case of being connected to an ADSL (Asymmetrical Digital Subscriber Line) modem and a cable modem of an external device.

The input unit 402 is the keyboard, the mouse etc, and detects the message information inputted by the use. Further, the keyboard and the mouse are used for executing other application software used by the user of the terminal device 201 as well as being used for detecting the message information necessary for the processing according to the invention of the present application. Moreover, the video camera might be used as the input unit 402.

The CPU 403 executes, in addition to the control of the whole personal computer, a variety of processes on the basis of the program data for the group information shared system for actualizing the processing according to the invention of the present application, which will hereinafter be explained.

The display unit 404 is a CRT (Cathode Ray Tube) or a liquid crystal display etc, and the screen display example in FIG. 3 is displayed on a part or an entire area on the display unit 404.

The ROM 405 is stored with commands and data required for the CPU 403.

The RAM 406 is used as a work memory necessary for an operation of the CPU 403.

The storage unit 407 is a hard disk drive etc. The storage unit 407 is stored with program data 409 for the group information shared system terminal device and, in addition, with data necessary for running the program data 409 for the group information shared system terminal device.

The system bus 408 consists of address lines, data lines, control lines and signal lines for the communications between the respective units such as the communication control unit 401, the input unit 402, the CPU 403, the display unit 404, the ROM 405, the RAM 406 and the storage unit 407.

FIG. 5 is a block diagram showing a configuration of the server apparatus 203 in the first embodiment. The server apparatus 203 is constructed of a computer for the server, and operates based on group information shared system server apparatus program data. The computer for the server includes a communication control unit 501, an input unit 502, a CPU 503, a display unit 504, a ROM 505, a RAM 506 and a storage unit 507.

The communication control unit 501 executes communication control for establishing the connections to the communication network 202 such as the Internet etc. Normally, the server apparatus 203 is installed at an NOC (Network Operation Center) of an internet service provider in close proximity to the Internet backbone network, and is therefore constructed of a fast interface for connecting to an NOC router as a communication interface. Further, in the case of operating the present group information shared system within the LAN, the server apparatus 203 is provided in the LAN.

The input unit 502, though it includes a keyboard and a mouse for managing the computer for the server, might manage the computer only via the network in some cases.

The CPU 503 controls the whole computer for the server and, in addition, executes processing based on the program data for the group information shared system server apparatus.

The display unit 504 is a CRT or a liquid crystal display etc, and displays necessary items of information.

The ROM 505 is stored with commands and data required for an operation of the CPU 503.

The RAM 506 is used as a work memory necessary for the operation of the CPU 503.

The storage unit 507 is a hard disk drive etc. The storage unit 407 is stored with the group information shared system server apparatus program data themselves and, in addition, with data necessary for running the group information shared system server apparatus program data, user's database-structured information (user database) and information about messages transmitted from the terminal device 201.

The system bus 508 consists of address lines, data lines, control lines and signal lines for the communications between the respective units such as the communication control unit 501, the input unit 502, the CPU 503, the display unit 504, the ROM 505, the RAM 506 and the storage unit 507.

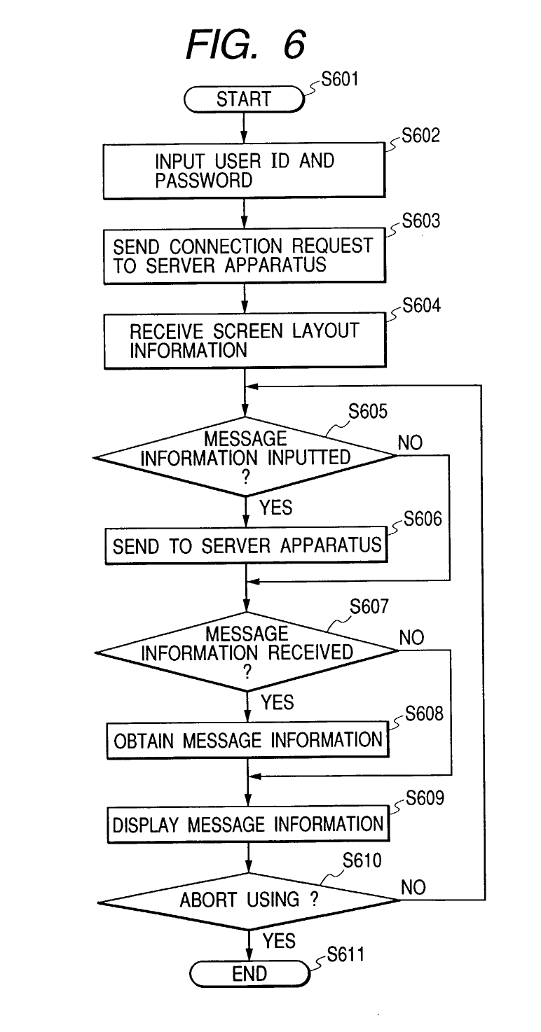

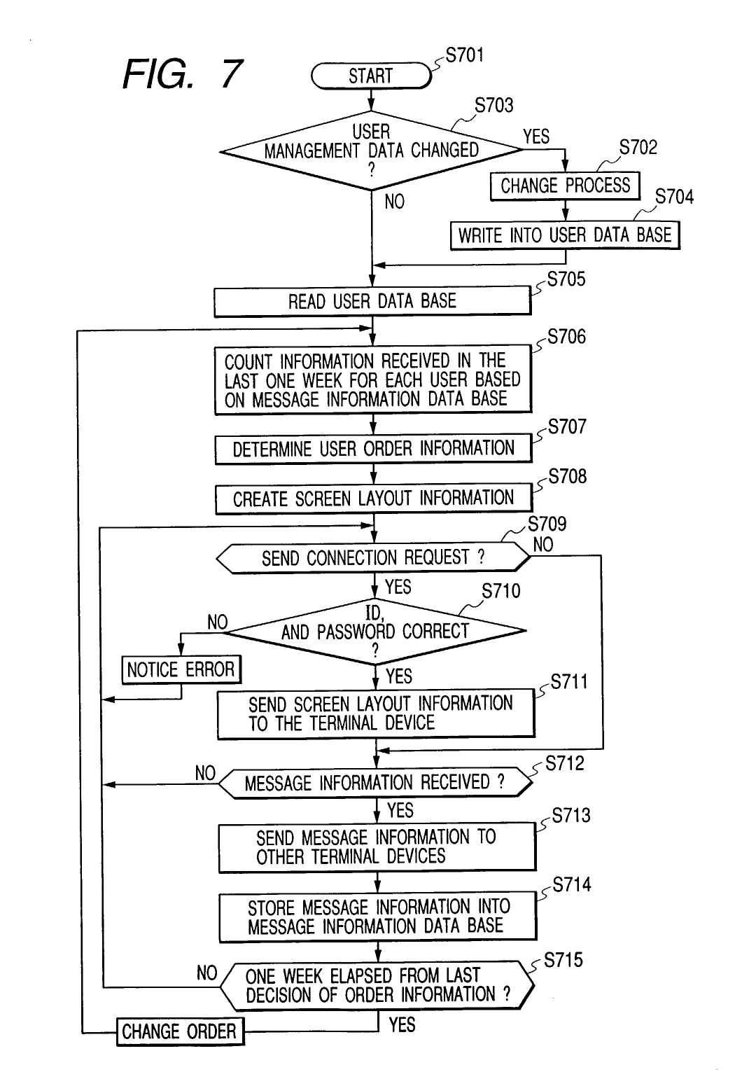

Next, a flow of the operation of the group information shared system having the architecture described above, will be discussed in depth with reference to flowcharts shown in FIGS. 6 and 7. Note that these flowcharts show a flow of control executed by the CPUs of the terminal device 201 and of the server apparatus 203 independently or in cooperation on the basis of the program data stored in the memories of the user terminal device 201 and of the server apparatus 203.

FIG. 6 is a flowchart related to the operation of the terminal device 201. FIG. 7 is a flowchart related to the operation of the server apparatus 203.

Note that the terminal device 201 and the server apparatus 203 be, it is assumed, previously connected to the communication network 202 (such as the Internet, the intranet etc) by use of the communication control units 401, 501 for simplifying the explanation.

The server apparatus 203, when the program data for the group information shared system server apparatus are booted, queries of an administrator (the administrator of the present message shared system) of the server apparatus 203 on the display unit 504 of the server apparatus, whether there is a change in the user registration information, and acquires a result of this query trough the input unit 502 (S702) If a change indication is inputted from the input unit 502, a content of this change is further inputted from the input unit 502 (S703) and written to the user database (S704).

If the writing to the user database is finished or if given a no-change indication or if not inputted from the input unit 502 for a fixed period of time in S704, the content stored in the user database is read from the storage unit 507 into the RAM 506 (S705).

Next, the number of receipts (which will hereinafter be termed a receipt count) of the message information per user within the fixed period of time in the past, which are stored in the storage unit 507, is counted by the program data for the group information shared system server apparatus (S706). The [fixed period of time] is set by the server administrator or the user. Normally, the [fixed period of time] is approximately one week and may also be one day or one month. Then, user order information is determined in order of the receipt count from the largest to the smallest (S707).

Note that the [message information] includes the character information (302), the image information (303) and the symbolic information (304) described above, and it can be considered that the following count modes may be taken when counting the receipt count of the message information in S706.

The receipt count of all items of message information is counter. Namely, the received character information, image information and symbolic information are equally counted. In this case, however, there might be a possibility in which the user providing not-so-useful pieces of information (for instance, the user frequently changing the symbolic information indicating a user's whereabouts) is counted more than the user frequently providing useful pieces of information) for example, the user providing the character information such as suggestions on business).

(2) The receipt count of a part of the message information is counted. For obviating the problem of the count mode (1), for example, the receipt count of the character information may be counted.

(3) The receipt count of the message information is counted in a way that puts a weight thereon. In the example of the count mode (2), other items of message information excluding the character information are not counted at all. It makes no difference that even other items of message information excluding the character information provide other users with information having some value, and hence there is a way of thinking that these items of information, even if little, should be reflected in counting the receipt count. Such being the case, it can be considered that weights are given to the respective items of message information, and these weighted items of message information are added up.

(Receipt Count)=A×(Receipt Count of Character Information)+B×(Receipt count of Image Information)+C×(Receipt count of Symbolic Information)

where A, B and C are constants. If the character information is conceived important, the constant A must be set larger than the constants B and C. Further, if the image information is not considered substantially important, the coefficient B of the image information may be set smaller than A and C.

Next, screen layout information is created by combining the order information with the contents in the user database and stored on the RAM 506 (S708).

The screen layout information is defined as information showing how the users are laid out on the screen on the basis of the order information and the user database. Generally, the user having the largest receipt count of the message information is disposed in the most conspicuous (the uppermost) area on the screen.

On the other hand, in the terminal device 201, when the program data for the group information shred system terminal device are booted, a screen for prompting the user to input a user ID and password is displayed on the display unit 404 (S602).

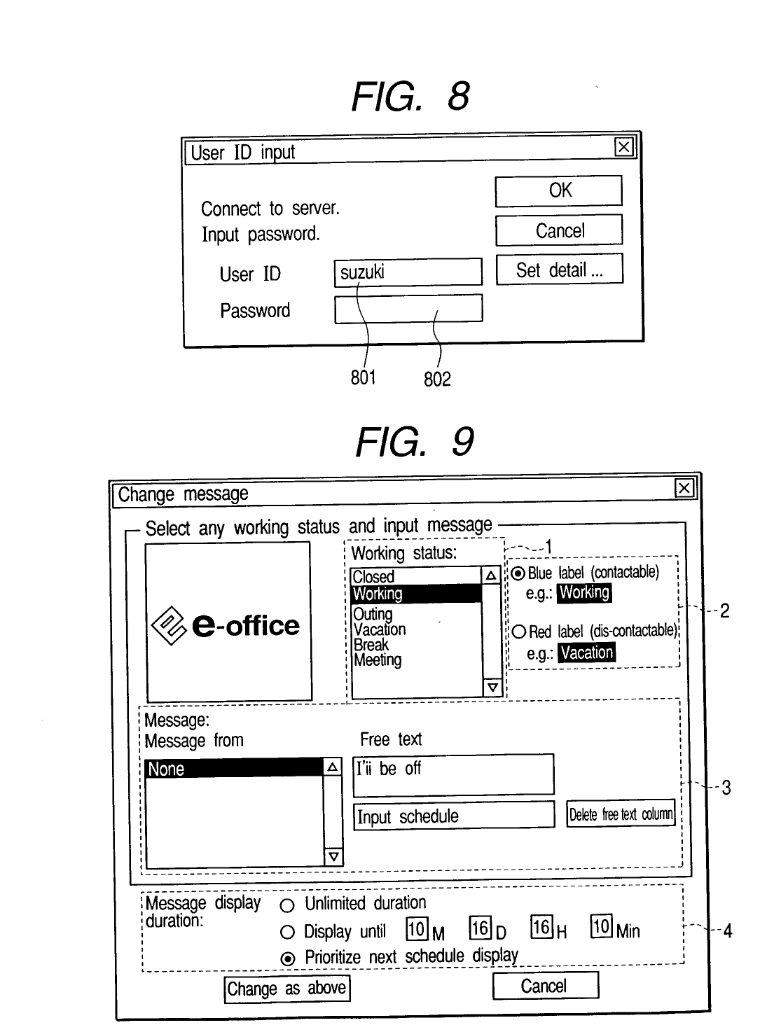

FIG. 8 shows the screen, for prompting the user to input the user ID and the password, displayed on the display unit 404. The numeral 801 represents an input box for the user ID, and 802 designates an input box for the password.

When the user ID and the password are inputted in S602, the terminal device 201 sends a connection request containing values of the ID and password to the server apparatus through the communication control unit 501 of the server apparatus via the communication network 202 (S603). The server apparatus, when receiving the connection request from the terminal device 201 (S709), collates the user ID and the password contained therein with the user information stored in the user database in order to judge whether the user ID and the password are valid or not (S710). If valid, the server apparatus transmits the screen layout information created in S708 to the terminal device having sent the connection request via the communication control unit 501 of the server apparatus, the communication network 202 and the communication control unit 401 of the terminal device 201 (S711). Whereas if the user ID and the password are invalid, the terminal device 201 is notified of an error, and the processing returns to S709.

The terminal device, when receiving the screen layout information (S604), displays the screen in accordance with the screen layout information.

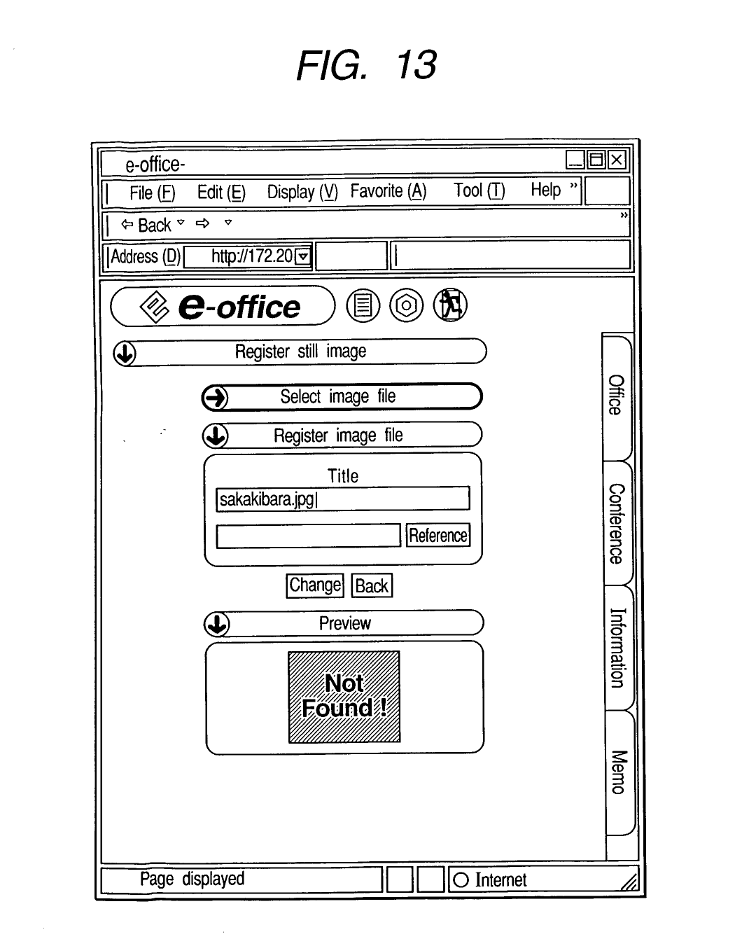

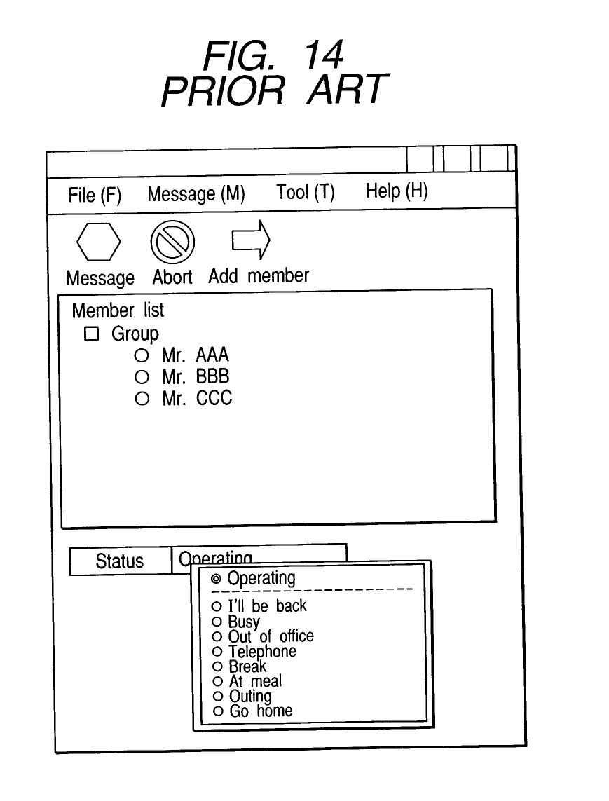

FIG. 9 is a view showing a screen for inputting the character information and the symbolic information. The inputting of the image information involves using a method of inputting the image information by registering a still image on the operation screen shown in FIG. 13, and inputting and periodically updating the image in a way that automatically takes in the image at a fixed time interval from the video camera by the function of the program data for the group information shared system terminal device program data of the terminal device 201 in the case where the terminal device 201 is provided with the video camera as a part of the input device 402.

Then, if the message information (the character information, the image information or the symbolic information) is inputted to the input unit 402 of the user terminal device 201, the inputted information is transmitted to the server apparatus 203 via the communication control unit 401 of the terminal device, the communication network 202 and the communication control unit 501 of the server apparatus. On this occasion, the message information contains the user ID of the user who sends the message concerned. The server apparatus 203, when receiving the message information from any one of the terminal devices 201 (S712), transfers and distributes the content of the message information (as it contains the user ID of the sender) to all the terminal devices 201 (S713).

The terminal device 201, when receiving the message information from the server apparatus 203 in S607, acquires the same message information (S608), displays the message information in a display position specified by the screen layout information in accordance with the screen layout information received beforehand from the server apparatus with reference to the user ID of the sender that is contained in that message information (S609).

For instance, in FIG. 3, the message information as the character information sent from the first user (given a user name [Suzuki general manager]) among twelve users registered, is displayed in a position 302, the message information as the image information is displayed in a position 303, and the message information as the symbolic information is displayed in a position 304. The contents of this display are displayed likewise on the display units 404 of the terminal devices of the registered twelve users in this example.

Thus, the users belonging to the same group are able to see the same screen on the display units 404 of the respective terminal devices, and, if one individual user has updated the message information, the updated information is, as described above, reflected on the display units 404 of the terminal devices of all the users through the server apparatus 203.

On the other hand, the server apparatus 203, upon a completion of the transfer distribution (S713), stores the message information database with the transferred message information containing the user ID of the sender (S714).

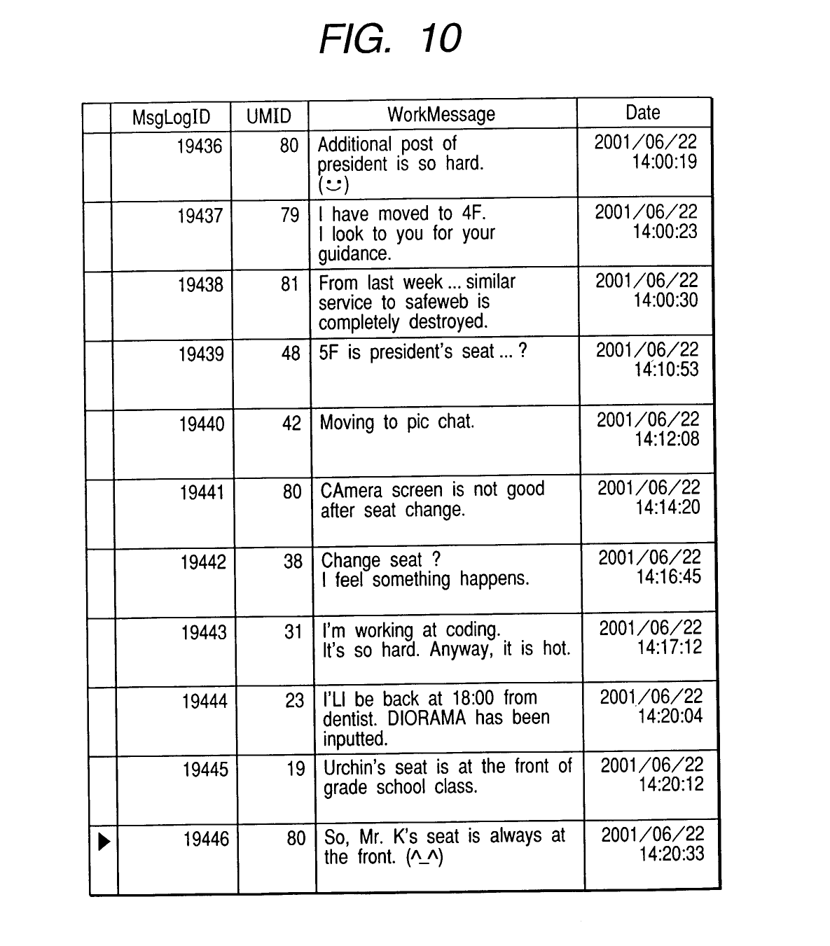

FIG. 10 is a diagram showing table-formatted user-by-user message information stored in the message information database.

The program data for the group information shared system server apparatus checks whether a fixed period of time (one week etc) has elapsed since the user display order determination processing executed last time (S707). If elapsed, the processing proceeds to S706 (Y in S715), wherein the receipt count of the message information per user is counted (S706). Then, the user order information is redetermined according to the receipt count from the largest to the smallest (S707).

A new set of screen layout information created by combining the new order information with the contents in the user database, is transmitted to the terminal device making the connection request after the processing described above.

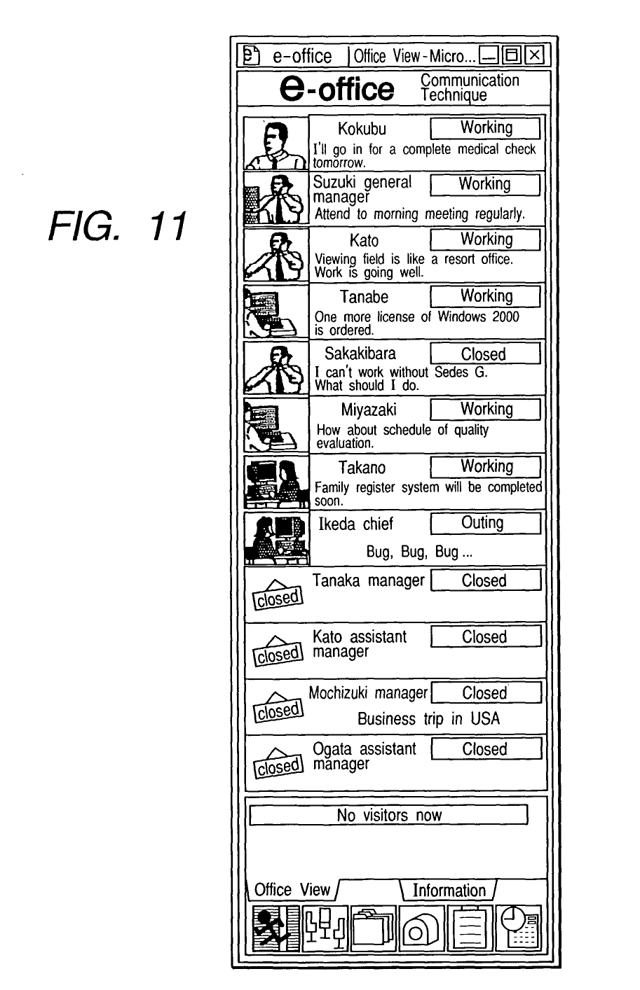

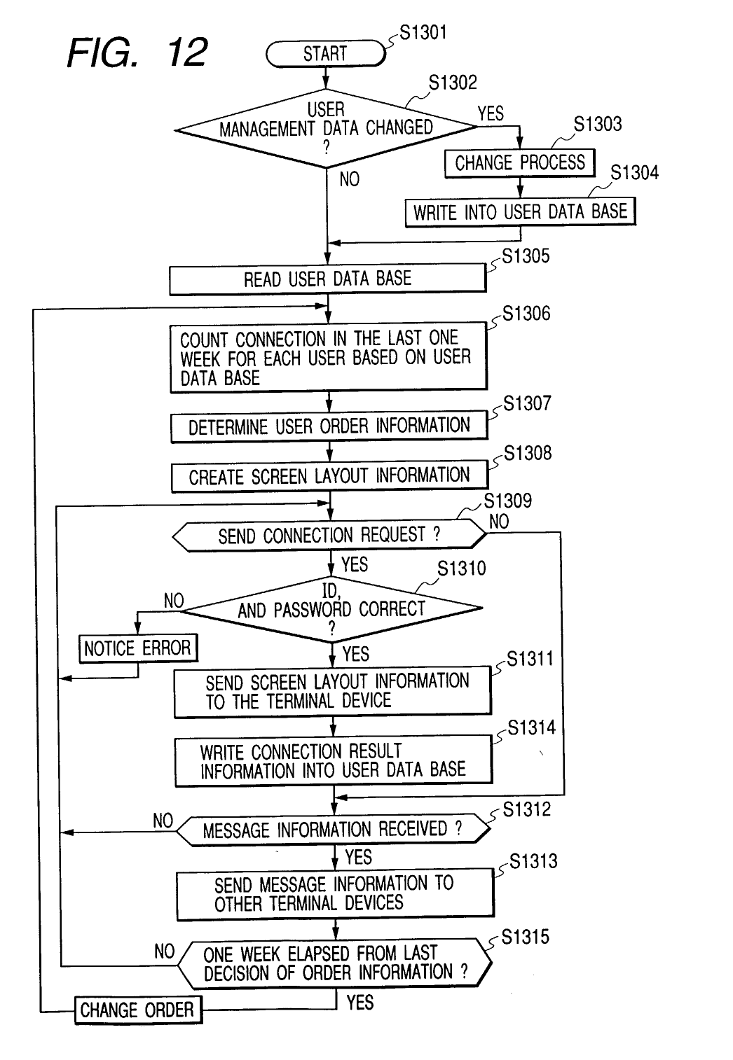

FIG. 11 shows a display example based on the new order information displayed on the display unit 404 of the terminal device 202 on the basis of the new lay out information. If in the conventional example (FIG. 3), the user named [Kokubu] providing the useful information to other users is to be positioned in a lower rank in the group and is, when order processing is executed in the first embodiment (FIG. 11), displayed in the uppermost position. By contrast, the user named [Mochizuki manager] providing a trace bit of information was displayed in the upper rank in the group according to the conventional example (FIG. 3), and is displayed in a lower rank in the group when executing the order processing in this embodiment (FIG. 11).

Thus, according to the first embodiment, the user providing the useful information to other users can be automatically efficiently disposed in the conspicuous position. Note that the first embodiment entails executing the order processing that the user having the larger receipt count of the message information is displayed in the higher area on the display unit, however, the display position may be rightward or leftward or downward if easy to visually recognize. Further, there may also be taken the easy-to-visually-recognize position in terms of a relationship with other display areas (windows). Moreover, the structure of the layout information may not be limited to what simply determines the ranking order but may include what lays out according to sizes and colors as well. Namely, the user exhibiting the larger receipt count of the message information may be displayed in a larger size and in a more vivid color (e.g., red).

According to the first embodiment, the program data for the group information shared system terminal device and the program data for the group information shared system server apparatus, run separately to execute the respective processing. These two categories of program data may also be structured into one common set of program data.

[Second Embodiment]

(Creation of Layout Based on Log-in Count)

(A second embodiment is substantially the same as the first embodiment, and therefore only different points are described. The constructive elements overlapped with the first embodiment are the same as those of the first embodiment.)

According to the first embodiment, the display order is determined based on the receipt count of the user messages from the largest to the smallest (S707). According to the second embodiment, however, a user's log-in count of the server apparatus is counted and stored, and the user order information is determined based on the log-in count from the largest to the smallest.

FIG. 12 is a flowchart showing processing of the server apparatus in the case of determining the display order based on a user's total log-in count.

As obvious from a comparison between FIG. 7 and FIG. 12, there is no great difference between the first embodiment and the second embodiment. In the first embodiment, the order information is created S707) by counting the receipt count of the message information within the fixed period of time (one week etc) (S706). Based on the thus created order information, the user having the larger receipt count of the messages is displayed in the higher position on the display screen. On the other hand, according to the second embodiment, the user order information is created (S1307) by counting the connection count (log-in count) per user within the fixed period of time (S1306). The user database is stored with information (connection result information) showing how many times the user logs in, wherein the connection result information is updated each time the user logs in (S1314).

Thus, the order information is determined based on the log-in count, whereby the many users participating in the group can be automatically efficiently displayed in the conspicuous positions on the screen.

[Third Embodiment]

(Creation of Layout Based on Total Log-In Time)

(A third embodiment is substantially the same as the first embodiment, and therefore only different points are described. The constructive elements overlapped with the first embodiment are the same as those of the first embodiment.)

In the second embodiment, the display order is determined based on how many times the user logs in the server apparatus. It can be, however, presumed that the user frequently leaving his or her seat and logging in many times might have a shorter cumulative log-in time than that of the user having a smaller log-in count.

According to the third embodiment, the server apparatus 203 measures a total time for which each user logs in the server apparatus by use of an internal clock in the server apparatus or an external clock provided outside the server apparatus, and determines the display order of the users in accordance with the total log-in time from the longest to the shortest. Thus, the order information is determined based on the total log-in time, whereby the users participating in the group for a longer period of time can be automatically efficiently displayed in the more conspicuous positions on the screen.

[Fourth Embodiment]

(Creation of Layout Based on Transmitted Data Size)

(A fourth embodiment is substantially the same as the first embodiment, and therefore only different points are described. The constructive elements overlapped with the first embodiment are the same as those of the first embodiment.)

In the first embodiment, the order information is determined based on the receipt count of the message information, however, it is difficult to judge whether the message information is essentially useful or not. A short message, though the receipt count is large, contains a small amount of information, and there are included a multiplicity of messages that should not be counted fundamentally. Such being the case, according to the fourth embodiment, the order information is to be determined based not on the receipt count of the message information but on a received data size of the message information. According to the first embodiment, supposing that a user A sent the message information five times while a user B sent the message information ten times, the user B is ranked higher than the user A. If a data size of the message information sent five times by the user A is 50 Kbytes and a data size of the message information sent ten times by the user B is 40 Kbytes, however, it can be said that the transmitted data size of the user A is larger than the transmitted data size of the user B.

As in the fourth embodiment, the order information is determined based bot on the receipt count of the message information but on the received data size of the message information, whereby there might be such a case that the layout information can be determined more properly.

[Fifth Embodiment]

(Creation of Layout Based on Composite Parameters)

(A fifth embodiment is substantially the same as the first embodiment, and therefore only different points are described. The constructive elements overlapped with the first embodiment are the same as those of the first embodiment.)

In the first through fourth embodiments, the order information is determined based on their independent criteria (the message receipt count, the log-in count, the log-in time and the received data size), and may also be determined by using these criteria in a composite manner. For instance, there is given a criterion such as:

(Criterion)=D×(Message Receipt Count)+E×(Log-in Count)+F×(Log-in Time)+G×(Received Data Size)

where D, F, F and G are constants, respectively. Then, the order information is determined based on this criterion. Constants of the message receipt count, the log-in count, the log-in time and the received data size are, though different in their mathematical dimensions, properly, thereby signifying the criterion given above.

Thus, in the case of determining the order information, the respective criteria are weighted and added up, thereby making it possible to create the more proper order information.

[Sixth Embodiment]

(Creation of Layout Based on Seating Time)

(A sixth embodiment is substantially the same as the first embodiment, and therefore only different points are described. The constructive elements overlapped with the first embodiment are the same as those of the first embodiment.)

In the first embodiment, the display order is determined according to the user message receipt count from the largest to the smallest. In the second embodiment, the display order is determined according to the number of times with which the user logs in the server apparatus. In the third embodiment, the display order is determined according to the user log-in time from the longest to the shortest. In the system of the present invention, however, there might be users who have comparatively small message transmission counts but run their eyes well through the messages, and there might be a case where these users, it is not desired, be lowered in their ranks (order). By contrast, there might be a case in which the users who leave away from the installed locations of the terminal devices 201 immediately after performing the log-in every morning and do not so often utilize the present system in spite of the great log-in count and log-in time thereof, and the ranks (order) of these users, it is desired, be lowered though great in their log-in count and log-in time.

Then, according to the sixth embodiment, availability of each of the keyboard and the pointing device provided on the input unit is detected as a function of the group information shared system terminal device program data of the terminal device 201, and a result of this detection is used as a piece of seating information (if one or both of the keyboard and the pointing device are kept used, a normal probability is that the user is at his or her seat, and, if none of these devices are used, a high probability is that the user leaves his or her seat, wherein the device-used case is set as a presumable pieces of seated information, and the device-unused case is set as a presumable piece of unseated information. The result is transmitted to the server apparatus at a fixed time interval (e.g., every 10 min.), and the server apparatus 203 measures a total time for which each user is at user's seat by use of the internal clock in the server apparatus or the external clock provided outside the server apparatus, and determines the user display order according to the seated time from the longest to the shortest.

Thus, the order information is determined based on the total seated time, whereby the users participating in the group for a longer period of time can be automatically efficiently displayed in more conspicuous positions on the screen.

[Seventh Embodiment]

(Creation of Layout Based on Recognition of Person)

(A seventh embodiment is substantially the same as the first embodiment, and therefore only different points are described. The constructive elements overlapped with the first embodiment are the same as those of the first embodiment.)

In the sixth embodiment, the availability of each of the keyboard and the pointing device provided on the input unit is detected as the function of the group information shared system terminal device program data of the terminal device 201, and the result of this detection is used as the seating information. In this case, if one or both of the keyboard and the pointing device are kept used, the probability is that the user is at his or her seat, and, if none of these devices are used, the high probability is that the user leaves his or her seat, wherein the device-used case is set as the presumable pieces of seated information, and the device-unused case is set as the presumable piece of unseated information. There might be, however, a case in which the user does not, though actually seated (siting at the desk), use the terminal device 201 such as the personal computer etc but perform other works (such as running the user's eyes through papers, telephoning, creating a material by handwriting and so on).

Then, according to the seventh embodiment, the system is equipped with the video camera as a part of the input unit 402 of the terminal device 201, and it is judged by picture recognition processing as a function of the program data for the group information shared system terminal device whether or not a person exists in a picture captured by the video camera. Then, the user is judged to be seated only when recognizing that the person exists therein, and a result thereof is transmitted to the server apparatus 203 at a fixed time period (e.g., every 10 min.), and the server apparatus 203 measures a total time for which each user is at the user's seat by use of the internal clock in the server apparatus or the external clock provided outside the server apparatus, and determines the user display order according to the seated time from the longest to the shortest.

Thus, the order information is determined by the total seated time on the basis of the recognition of the seated state by use of the picture recognition processing, whereby the users participating in the group for a longer period of time are precisely grasped, and can be automatically efficiently displayed in more conspicuous positions on the screen.

Note that the detection of the seated state involves detecting the use of the input unit 402 in the sixth embodiment discussed above, however, the total seated time may be measured using a result of a multimodal seating detection that involves a combination of these two different detection methods. The multimodal seating detection is a know technique, and hence its explanation is omitted. According to this seating detection method, however, if the use of the input unit is detected, it is judged that the user is for sure at the seat. Whereas if the use of the input unit is not detected, the seated state is judged depending on the detection involving the use of the picture recognition processing, whereby the seated state can be grasped more accurately, and the user display order is determined according to the seated state from the longest to the shortest.

[Eighth Embodiment]

(Creation of Layout Based on Affairs Results)

(An eighth embodiment is substantially the same as the first embodiment, and therefore only different points are described. The constructive elements overlapped with the first embodiment are the same as those of the first embodiment.)

In a general organization, the ranking according to posts (the chief of division, the chief of section, the head of section, the general staff) and the seniority (the age, the entrance year), are bases for promoting the affairs.

On the other hand, changes in the pecking order based on the conventional post system and the seniority, are underway corresponding to changes in the business paradigm and in the environments for employment in recent years. There will be considered a possibility from now into the future, wherein it is not necessarily proper that the display order of the users of the instant messaging application and the groupware system in that category of ranking system. There is, for instance, a scheme that a group or user display order is determined corresponding to a sales scale, an amount of profits, accomplishments of a variety of targets etc related to the affairs results in the organization to which the group or the user belongs, and display control of frequently permuting the display order based on transitions of the sales and accomplishments etc, is actualized. This scheme stimulates a competitive sprit between the groups or between the users, a contribution of the group or the user having achieved an excellent result is admired by displaying them in the high positions, while the group or the user having exhibited a poor result is prompted to make further efforts by displaying them in the lower position, whereby such an effect, it can be considered, is obtained.

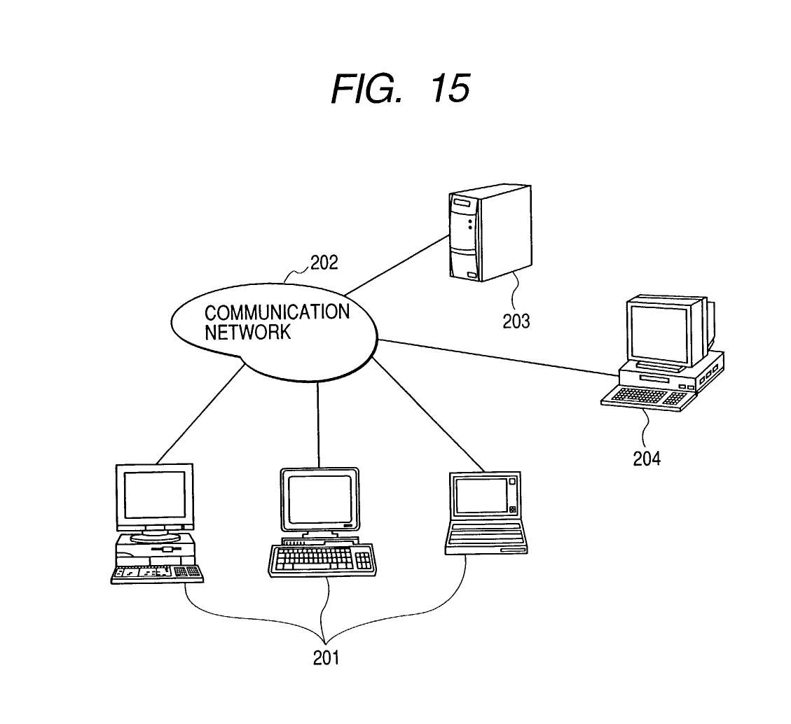

FIG. 15 is a view showing a system architecture of the whole group information shared system in this embodiment. In FIG. 15, the configurations other than a result management system apparatus 204 are the same as those in FIG. 2, and their explanations are omitted.

The result management system apparatus 204 incorporates the communication function and is connected to the communication network 202 as in the case of the terminal device 201. Note that the result management system apparatus 204 is classified as a computer etc for the result management system apparatus, and operates based on program data for the result management system apparatus.

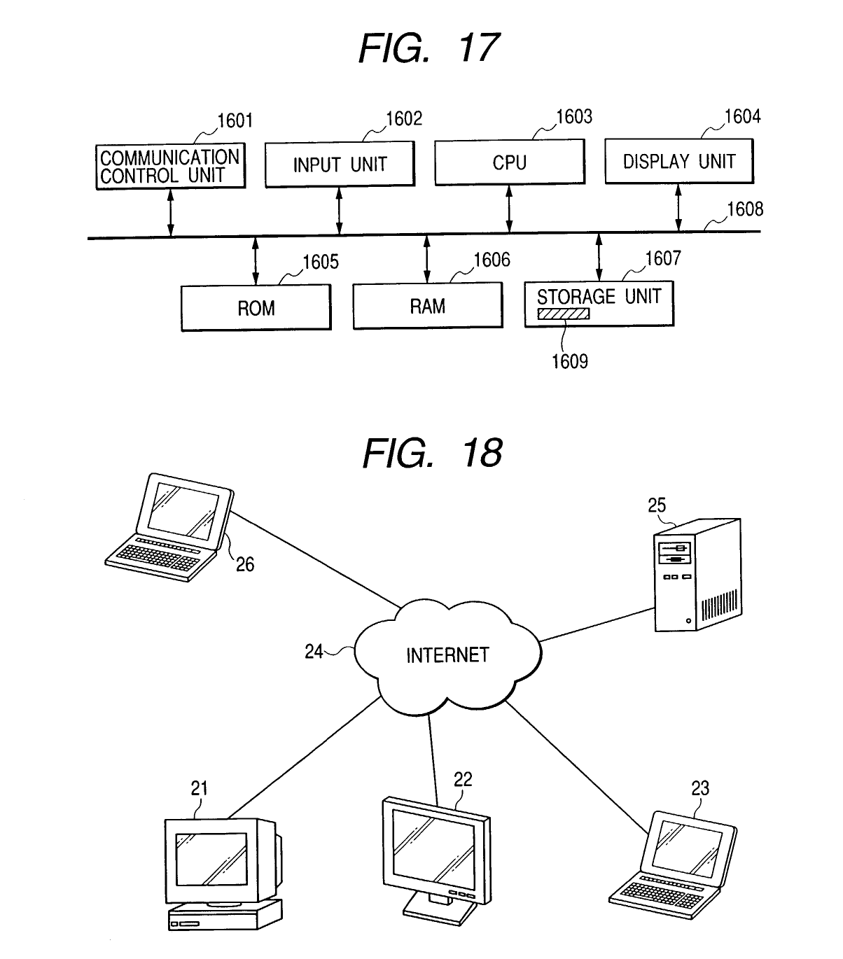

FIG. 17 is a block diagram showing a configuration of the result management system apparatus 204 in this embodiment.

The result management system apparatus 204 is constructed of the computer for the result management system apparatus, and operates based on the program data for the result management system apparatus. The computer for the result management system apparatus includes, as in the case of the computer 203 for the server apparatus, a communication control unit 1601, an input unit 1602, a CPU 1603, a display unit 1604, a ROM 1605, a RAM 1606 and a storage unit 1607. The configurations and operations of these components are substantially the same as those of the computer 203 for the server apparatus described above, and the following discussion will be focused on only different points, wherein the explanations of the same configurations and operations are omitted.

The storage unit 1607 of the result management system apparatus 204 is a hard disk drive etc, and is stored with the result management system apparatus program data themselves and, in addition, with data necessary for running the result management system apparatus program data, and user's database-structured information (user database).

Especially in the result management system apparatus 204, the storage unit 1607 is stored with pieces of information about scores of the affairs results of the individual users and scores of the affairs results of the groups each consisting of the plurality of users as well as with pieces of information on names of the users, the belong-to group and attributes thereof. Mainly a supervisor (such as the chief of division etc) or a person in charge of personnel affairs among the users of the group information display system according to the present invention, inputs those pieces of information by use of the input unit 1602 of the result management system apparatus 204, however, the same information might be inputted by other information communication device and transferred via the communication network 202.

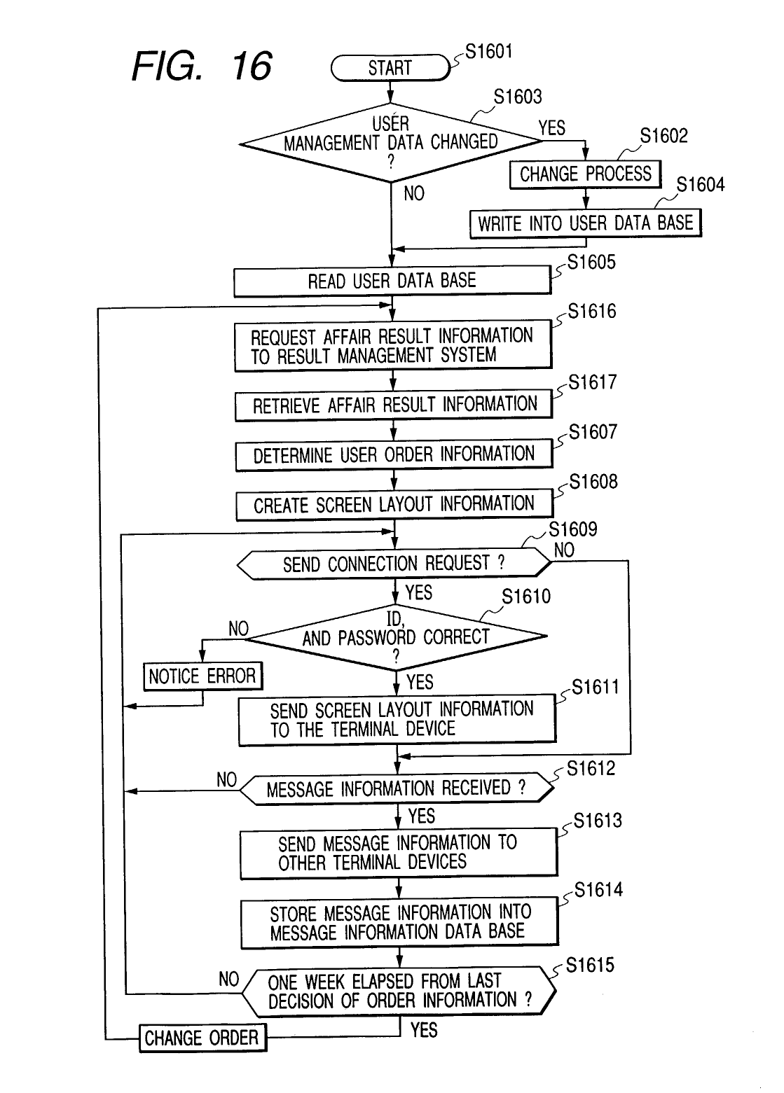

FIG. 16 is a flowchart showing an operation of the server apparatus 203. Incidentally, it is assumed for simplifying the explanation that the terminal device 201 and the server apparatus 203 be previously connected to the communication network 202 (such as the Internet, the intranet and so on) by use of the communication control units 401, 501, and the result management system apparatus 204 be likewise connected to the communication network 202, and the result management system apparatus 204 be stored with the affairs result information of the individual users of the terminal devices 201.

The server apparatus 203, when the program data for the group information shared system server apparatus are booted, queries of the administrator (the administrator of the present message shared system) of the server apparatus 203 on the display unit 504 of the server apparatus, whether there is a change in the user registration information, and acquires a result of this query trough the input unit 502 (S1602). If a change indication is inputted from the input unit 502, a content of this change is further inputted from the input unit 502 (S1603) and written to the user database (S1604).

If the writing to the user database is finished or if given a no-change indication or if not inputted from the input unit 502 within a fixed period of time in S1604, the content stored in the user database is read from the storage unit 507 into the RAM 506 (S1605).

Next, an acquisition request of the affairs result information is sent to the result management system apparatus 204 via the communication network 202 by a function of the program data for the group information shared system server apparatus (S1616). When receiving the affairs result information as a response thereto (S1671), the same affairs result information is cached in the storage unit 507, and the order information is determined based on the affairs result information in a way that ranks the users according to the affairs result from the superior to the inferior (s1607).

Note that the affairs result information is information about the scores of the affairs results (such as an amount of output and so forth) of the individual users, which are inputted and saved in the result management system apparatus 204. According to this embodiment, the affairs result information is defined as, for example, quantitative information on the number of inventions, the number of written technical papers, the number of designed drawings, the number of steps of created software of each individual user belonging to the technical division shown in FIG. 3, and as qualitative information about qualities thereof. The supervisor etc of the division concerned, as described above, inputs and saves those pieces of information through the input unit of the result management system apparatus 204 at a certain time.

Note that the affairs result information of the technical division has been exemplified as described above, however, the group information display system of the present invention can be, without being limited to the technical division, applied to, e.g., a sales (business) division. In this case, the affairs result information may be exemplified such as a sales result (the number of sales articles and an amount of proceeds), an accomplishment factor of a sales target of each of the users, and so on.

Next, the screen layout information is created by combining the order information with the contents in the user database and stored on the RAM 506 (S1608). The subsequent story is the same as in the first embodiment and is therefore omitted.

Thus, according to this embodiment, the scheme is that the user display order is determined corresponding to the user affairs result, and the display control of frequently permuting the display order on the basis of the transitions of the affairs results, is actualized. This scheme stimulates the competitive sprit between the groups or between the users, the contribution of the user having achieved an excellent result is admired by displaying him or her in the high position, while the user having exhibited a poor result is prompted to make further an effort by displaying him or her in the lower position, whereby such an effect can be obtained.

[Ninth Embodiment]

(Creation of Layout Based on Business Results)

(A ninth embodiment is substantially the same as the eighth embodiment, and therefore only different points are described. The constructive elements overlapped with the eighth embodiment are the same as those of the eighth embodiment.)

In the eighth embodiment, as shown in FIGS. 3 and 11, a certain single group (named the communication technique group) is displayed on the screen of each user, the user ranking order in the group is determined based on the affairs result information about the individual users, and the display control corresponding thereto is carried out.

The group display system according to the present invention is, however, capable of displaying the plurality of groups and the users belonging to each group on the screen of each user. In this case, according to the eighth embodiment, the user ranking order in the group is determined based on the affairs result information on every user, and the display control is executed corresponding thereto. In the ninth embodiment, however, the result management system apparatus 204 may manage and save the score of the affairs result information of not each individual user but each group, and may determine the ranking (order) among the groups, whereby the display control based on this ranking among the groups each categorized as a cluster (which is given a group name and consists of an aggregation of the users belonging to each group).

[Tenth Embodiment]

(Creation of Layout Based on Group Affairs Result Information and User Affairs Result information)

In a combination of the eighth and ninth embodiments, the result management system apparatus 204 may manage both of the group affairs result information and the intra-group user affairs result information, and may execute the control in a way that reflects the affairs results of both of the group and the user in the display by use of the group affairs result information with respect to the pecking order among the groups and the user affairs result information with respect to the pecking order among the users belonging to the same group. The details of the control are the same as those in the eighth embodiment, and hence the explanation thereof is omitted.

[Eleventh Embodiment]

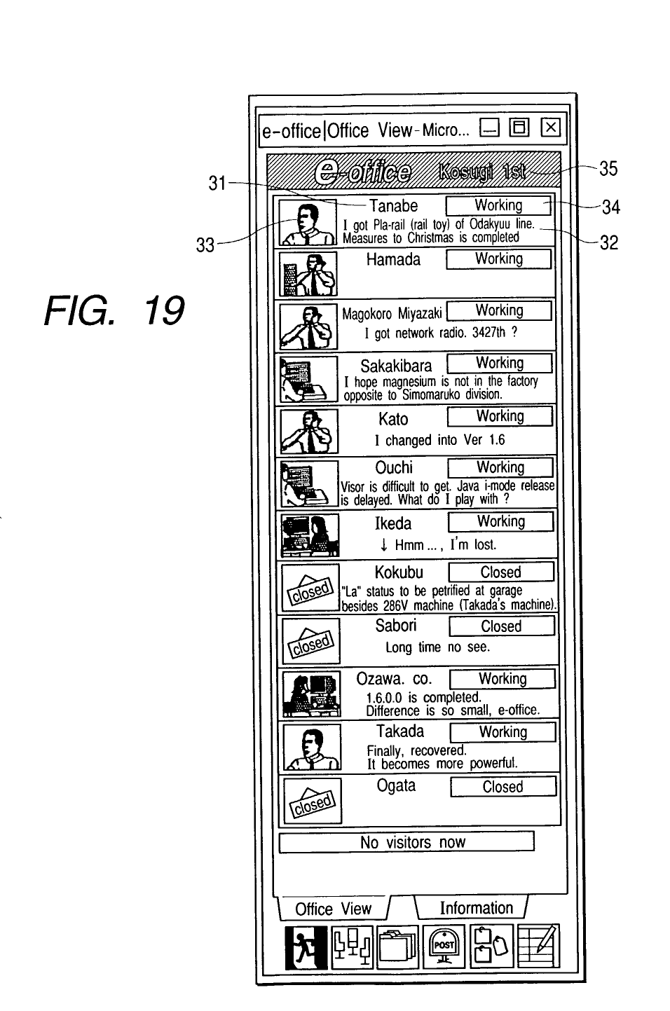

FIG. 18 is a view illustrating a system architecture of a whole message shared system in an eleventh embodiment. Referring to FIG. 18, the numerals 21 through 23 represent user terminal devices each incorporating the communication function and connected to the Internet 24. Note that each of the user terminal devices 21 through 23 is configured by the personal computer, the program data for the message shared system terminal device, and so on. The numeral 25 designates a server apparatus incorporating the communication function and connected to the Internet 24 as in the case of the user terminal devices 21 through 23. Note that the server apparatus 25 is configured by the computer for the server, the program data for the message shared system server apparatus, and so on. The numeral 26 denotes a terminal device of a system administrator. The terminal device 26 incorporates the communication function and is connected to the Internet 24 as in the case of the user terminal devices 21 through 23. Note that the terminal device 26 for the system administrator is configured by the computer for the system administrator, the program data for the system administrator, and so forth.

FIG. 19 is a diagram showing one example of a screen displayed on each of the user terminals 21 through 23 when operating the message shared system.

The numeral 31 designates a user name, 32 stands for a piece of message information (character information) sent by the user concerned, 33 represents a piece of message information (image information) sent by the user concerned, and 34 indicates a piece of message information (symbolic information) sent by the user concerned. FIG. 19 shows how twelve users are registered and utilize the message shared system. The numeral 35 in FIG. 19 designates a name of the group to which these users belong. Note that the display screen shown in FIG. 19 is displayed on the user terminal devices of all the users.

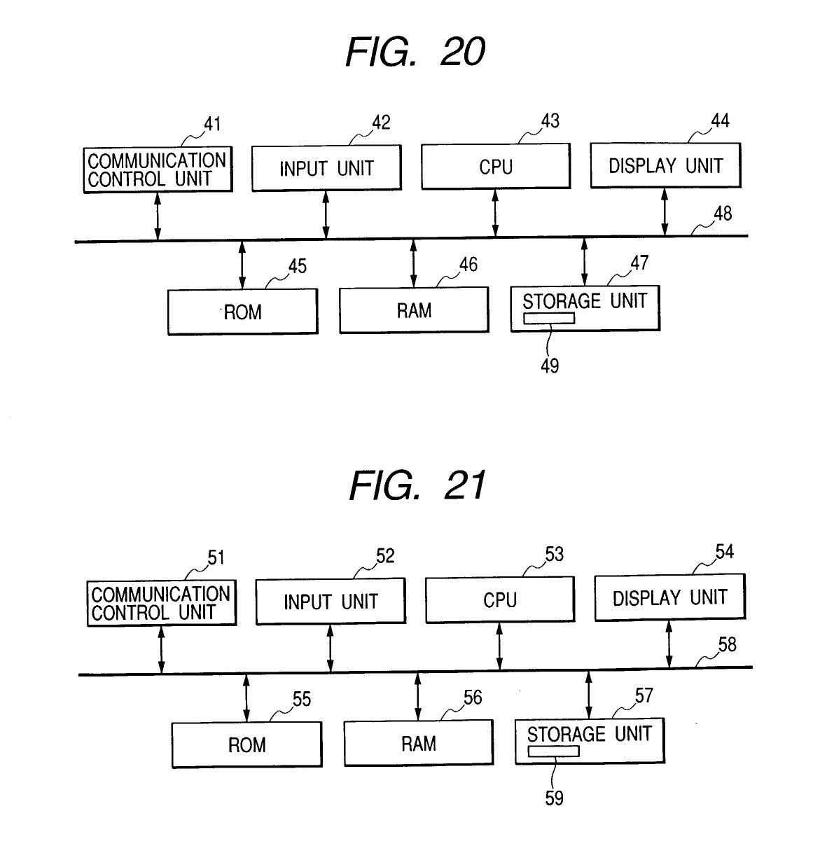

FIG. 20 is a block diagram showing a configuration of each of the user terminal devices 21 through 23. Each of the user terminal devices 21 through 23 has the configuration illustrated in FIG. 20.

Each of the user terminal devices 21 through 23 is configured by a personal computer (including other categories of information processing terminals such as PDA (Personal Digital Assistant), a mobile phone and so forth) and by program data for the message shared system terminal device. The personal computer includes a communication control unit 41, an input unit 42, a CPU 43, a display unit 44, a ROM (Read Only Memory) 45, a RAM (Random Access Memory) 46 and a storage unit 47. The program data for the message shared system terminal device are stored in the storage unit 47 and read into the RAM 46.

The communication control unit 41 executes processing of the communication control for establishing the connection to the Internet 24, and provides various categories of communication interfaces corresponding to user's equipment environments. The communication control unit 41 is, when making a direct connection to the access network, constructed of various types of modems and a terminal adapter and is also, when connected to an ADSL (Asymmetrical Digital Subscriber Line) modem and a cable modem of an external device, constructed of an Ethernet interface.

The input unit 42 is constructed of the keyboard and the pointing device (mouse) of the personal computer, and detects the message information inputted by the user. Note that the input unit 42 may in some cases include, in addition to the keyboard and the pointing device, a video camera by which the image information is converted into electric signals and formatted as one category of message information.

The CPU 43 executes, in addition to the control of the whole personal computer, processing indicated by the program data for the message shared system terminal device.

The display unit 44 is constructed of a CRT or a liquid crystal display and a control circuit thereof. The display screen shown in FIG. 19 is what is displayed on a part of screen of the CRT or the liquid crystal display.

The ROM 45 is stored with commands and data required for an operation of the CPU 43.

The RAM 46 is used as a work memory necessary for the operation of the CPU 43.

The storage unit 47 is constructed of a hard disk drive. The storage unit 47 is stored with program data for the message shared system terminal device and, in addition, with data necessary for running the program data for the message shared system terminal device.

Respective blocks 41 through 47 are connected to a system bus 48.

Note that the message shared system terminal device program data configuring a software architecture of each of the user terminal devices 21 through 23, to be specific, correspond to information 49 stored in the storage unit 47, and the personal computer corresponds to the respective components 41 through 48.

FIG. 21 is a block diagram illustrating an internal configuration of a server apparatus 25.

The server apparatus 25 is configured by a computer for the server and program data for the message shared system server apparatus. The personal computer for the server includes a communication control unit 51, an input unit 52, a CPU 53, a display unit 54, a ROM 55, a RAM 56 and a storage unit 57. The program data for the message shared system server apparatus are stored in the storage unit 57 and read into the RAM 56.

The communication control unit 51 executes the processing of the communication control for establishing the connection to the Internet 24, however, normally, the server apparatus 25 is installed at an NOC (Network Operation Center) of an internet service provider in close proximity to the Internet backbone network, and is therefore constructed of a first Ethernet interface for connecting to an NOC router as a communication interface.

The input unit 52 is constructed of the keyboard and the pointing device (mouse) of the personal computer for the server. Note that the server apparatus 25 may not in some cases include the input unit 52 and may be managed only via the network.

The CPU 53 executes, in addition to the control of the whole personal computer for the server, processing indicated by the program data for the message shared system server apparatus.

The display unit 54 is constructed of a CRT or a liquid crystal display and a control circuit thereof.

The ROM 55 is stored with commands and data required for the CPU 53.

The RAM 56 is used as a work memory necessary for the operation of the CPU 53.

The storage unit 57 is constructed of a hard disk drive. The storage unit 57 is stored with a program for the message shared system server apparatus and, in addition, with data necessary for running the program for the message shared system server apparatus and user database information as well.

Respective blocks 51 through 57 are connected to a system bus 58.

Note that the message shared system server apparatus program data configuring a software architecture of the server apparatus 25, to be specific, correspond to information 59 stored in the storage unit 57, and the personal computer for the server corresponds to the respective components 51 through 58.

The configuration of the terminal device for the system administrator is substantially the same as that of the user terminal device shown in FIG. 20, and therefore the discussion will be focused on only different points.

The CPU 43 executes, in addition to the control of the whole personal computer, processing indicated by the program data for the system administrator in the terminal device for the system administrator.

The storage unit 47 is stored with the program data for the system administrator and, in addition, with the data required for running the program data for the system administrator in the terminal device for the system administrator.

Note that the system administrator program data configuring a software architecture of each terminal device 26 for the system administrator correspond, to be specific, the information 49 stored in the storage unit 47, and the personal computer corresponds to the respective components 41 through 48.

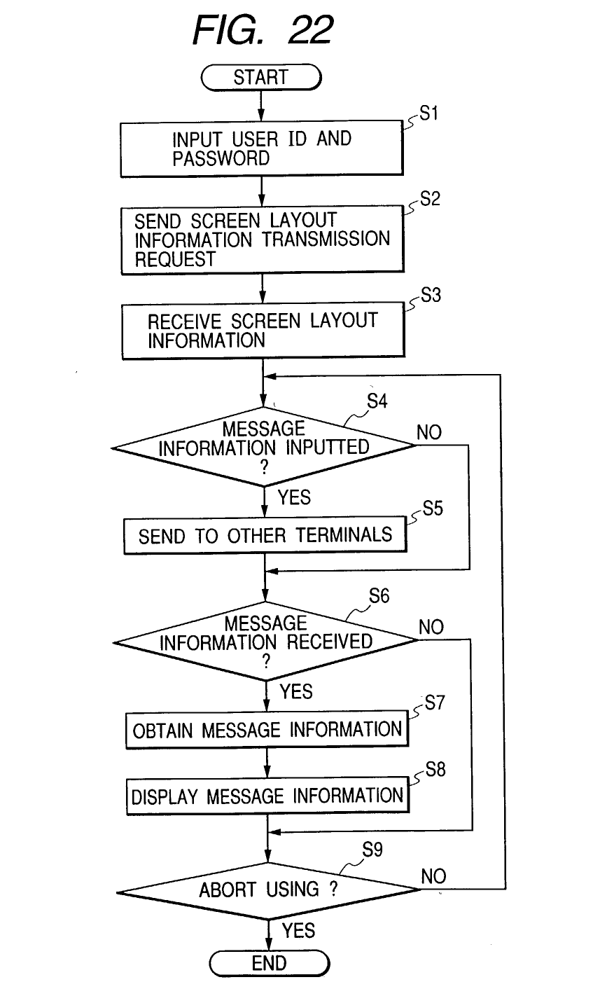

Next, a flow of operation of the distributed casting type message shared system having the architecture described above, will be explained in depth with reference to FIGS. 22, 23 and 26.

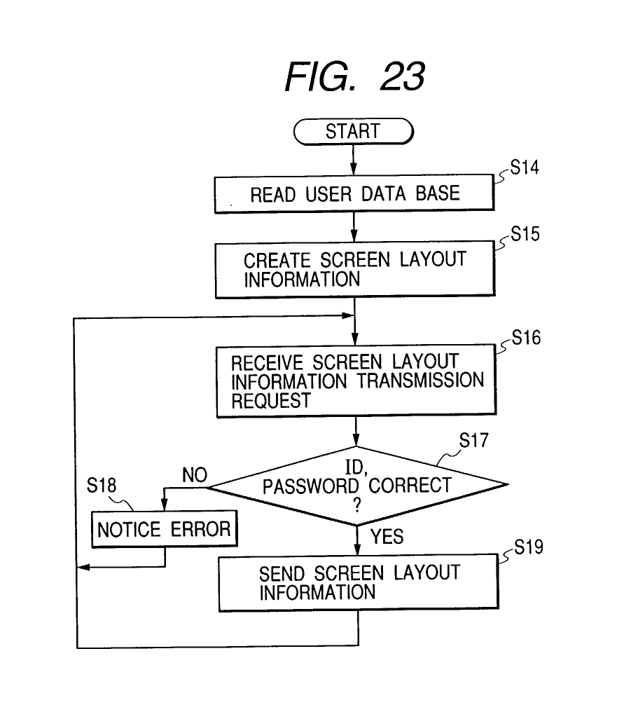

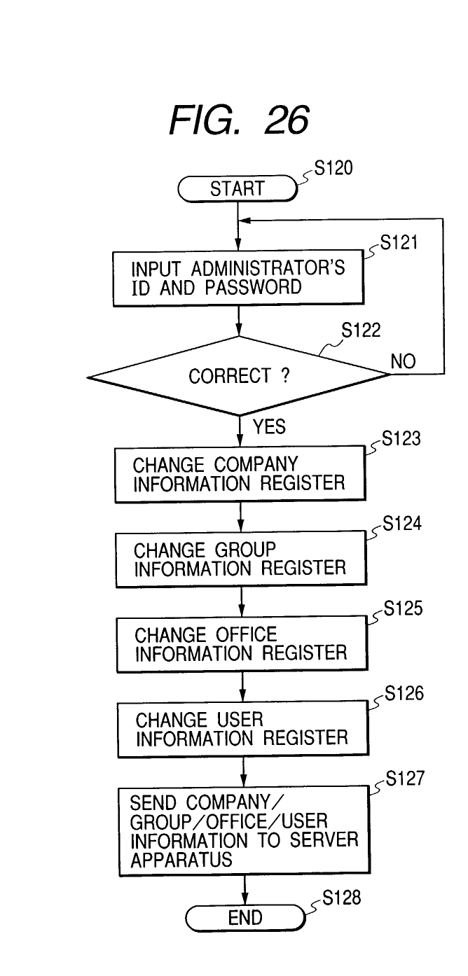

FIG. 26 is a flowchart showing operating steps of the terminal device 26 for the system administrator. FIG. 22 is a flowchart showing operating steps of each of the user terminal devices 21 through 23. FIG. 23 is a flowchart showing operating steps of the server apparatus 25. Note that these operations are actualized by the CPUs 43, 53 (not shown with respect to the system administrator terminal device 26) each executing the programs stored respectively in the RAMs 46, 56 of the user terminal devices 21 through 23, the server apparatus 25 and the terminal device 26 for the system administrator.

Herein, it is assumed for simplifying the description that the user terminal devices 21 through 23, the server apparatus 25 and the system administrator terminal device 26, be already connected to the Internet 24 by use of the communication control units 41, 51 thereof.

According to the message shared system of the present invention, the system administrator previously determines the users and the display order displayed on the terminal devices of the users in advance of being all utilized and inputs, it is required, this display order by use of the input unit 42 of the system administrator terminal device 26. More specifically, the user information inputted from the input unit 42 of the system administrator terminal device 26 is stored as user database information in the storage unit 57 provided in the server apparatus 25 via the Internet 24.

FIG. 26 shows the flow in the case of an initial registration. The system administrator inputs an ID and a password for the administrator (S121) and, if the inputted password is valid, can make an initial registration of the user information or can change the already-registered user information (S122).

According to this embodiment, there exist a plurality of groups defined as [Office] to which the individual users belong. The user management is conducted based on three hierarchies such as company, group and office, and hence the system administrator, on the occasion of the initial registration, registers at first the company information, next the group information and finally the office information, and thereafter registers the user information on the users belonging to the office concerned. The following an operation example of a program for the system administrator.

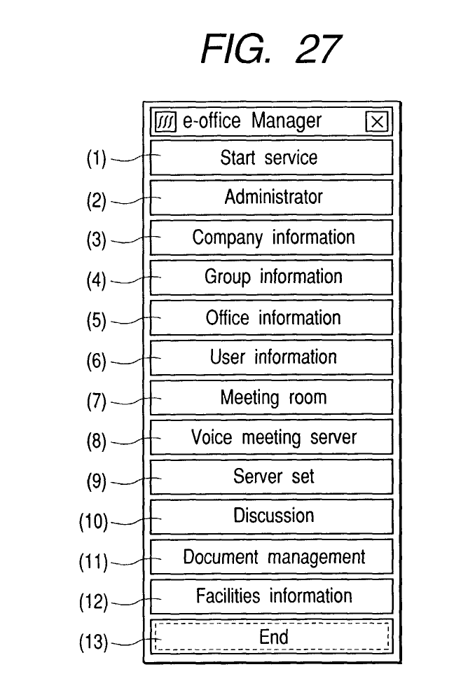

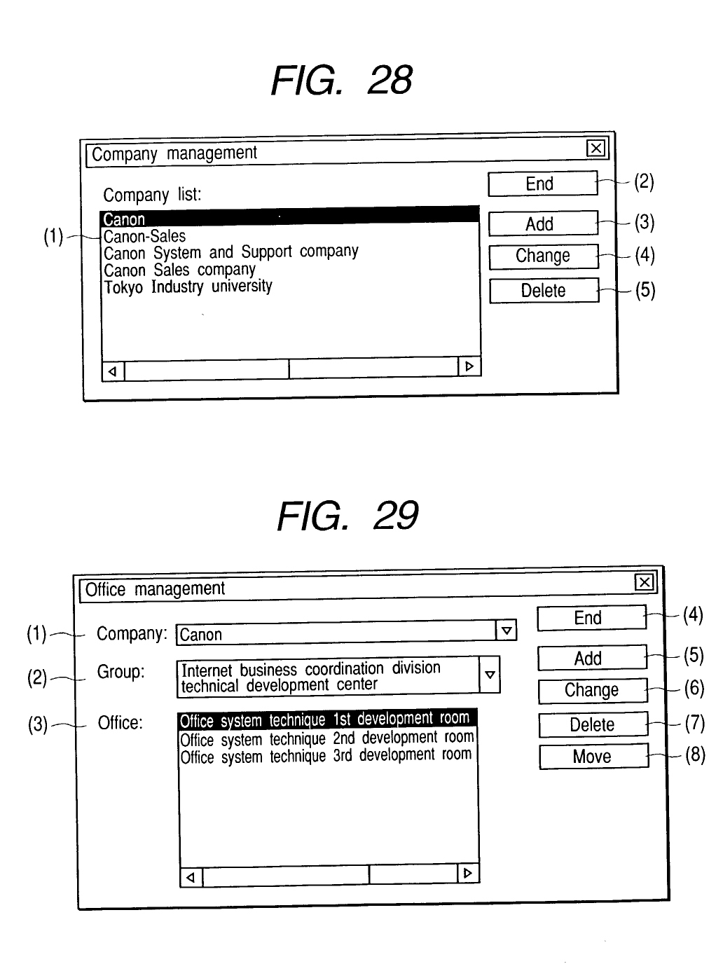

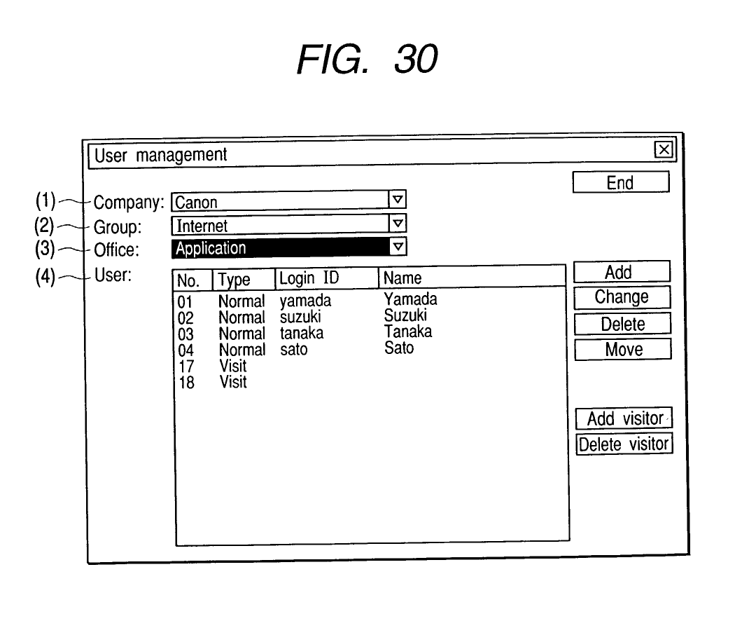

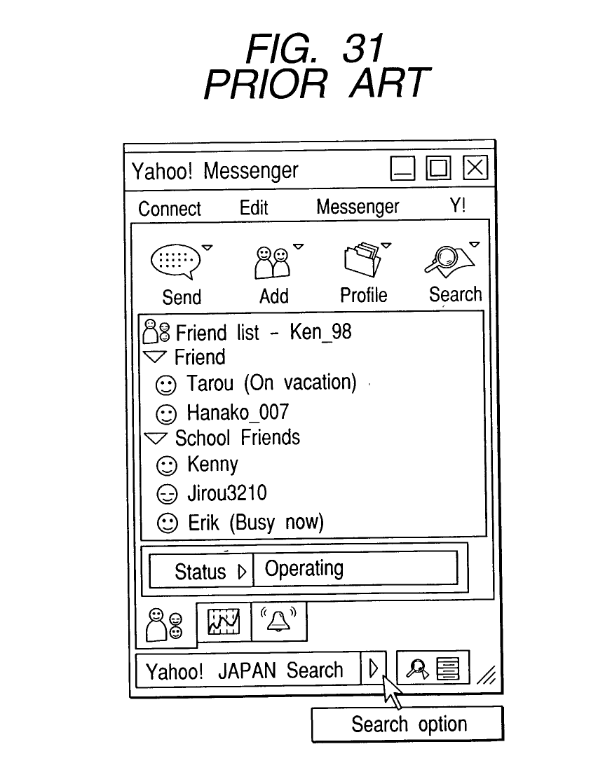

FIG. 27 shows a part or the whole of the screen (window screen) displayed on the display unit 44 of the system administrator terminal device immediately after booting the system administrator program. FIG. 28 shows a screen when registering and changing the company information (S123). FIG. 29 shows a screen when registering and changing the group and office information (S124, S125). FIG. 30 shows a screen when registering and changing the user information (S126). Note that even if the sequence of steps S123 through S126 is permuted, the object can be, as a matter of course, accomplished.

As shown in FIG. 30, four users such as Yamada, Suzuki, Tanaka and Satoh have already been registered. In this case, pieces of message information of the four users are invariably displayed in the above order (i.e., the order on the displayed screen shown in FIG. 30) on all the user terminal devices of all these four users. Thus, upon finishing the registration of the user information containing the user order (coincident with the display order), the system administrator program data send all the registered information as user database information to the server apparatus 25 via the Internet (S127).

The operation of the server apparatus 25 will hereinafter be described with reference to the flowchart in FIG. 23.

The CPU 53 of the server apparatus 25 reads contents stored on the user database of the storage unit 57 (S14) and writes the contents to the RAM 56. Then, the CPU 53, based on the readout contents, creates screen layout information and stores the same layout information in the RAM 56 (S15). The screen layout information is information for specifying display positions (order) of the registered users per group, display positions of pieces of message information etc on the display screen.

On the other hand, the user terminal device displays on the display unit 44 a screen (FIG. 8) for prompting the user to input a user ID and a password. The user terminal device, when inputting the user ID and the password (S1), transmits a screen layout information transmission request containing values of the user ID and the password to the communication control unit 51 of the server apparatus 25 through the communication control unit 41 across the Internet 24 (S2), and further transfers the same information to the CPU 53 of the server apparatus 25.

The server apparatus 25, when receiving the screen layout information transmission request from the user terminal device (S16), collates the user ID and the password contained therein with the user registration information recorded on the user database, and thus judges (authenticates) whether coincident with each other (S17). If authenticated valid, the server apparatus 25 reads one set of screen layout information related to the group to which the user having the user ID and the password concerned belongs, out of plural sets of screen layout information stored in the RAM 56 step S15, and sends the readout screen layout information to the communication control unit 41 of the user terminal device having sent the screen layout information transmission request (S19). The same screen layout information is then transferred to the user terminal device.

Whereas if neither the user ID nor the password is authenticated valid, the user terminal device having sent the screen layout information transmission request is notified of an error (S18). Note that the screen layout information contains attribute information such as IP addresses of the user terminal devices of all other users participating in the message shared system. When the user terminal device receives the screen layout information from the server apparatus 25 (S3), it is judged whether the message information consisting of the character information, the image information or the symbolic information is inputted from the input unit 42 of the user terminal device (S4).

FIG. 9 is a diagram showing a screen for inputting the message information. If the message information is inputted from the input unit 42, the IP addresses contained in the screen layout information are referred to, and the inputted message information is multicast to the user terminal devices of all other users (S5). On this occasion, the message information is attached with the user Ids of the users to which the same message information is to be multicast. Incidentally, if none of the message information is inputted, the processing skips over step S5.

The user terminal device judges whether the message information is received from the user terminal device of other user (S6). In the case of receiving the message information, the same information is obtained (S7). Then, the user ID attached to the message information is referred to, and, in accordance with the screen layout information received beforehand from the server apparatus 25, the message information is displayed in the display position, specified by the screen layout information, for the user having the user ID concerned (S8). Note that the processing skips over steps S7 and S8 in the case of judging in step S6 that the message information is not received.

Thereafter, it is judged whether the use of the user terminal device is finished (S9). If finished, the operation of the user terminal device is stopped. Whereas if not finished, the processing loops back to step S4.

Thus, for example, in the screen example shown in FIG. 19, the message information as the character information transmitted from the first user (given a user name [Tadokoro] in FIG. 19) among the twelve users registered, is displayed in a position 32, the message information as the image information transmitted from the same user is displayed in a position 33, and the message information as the symbolic information transmitted from the same user is displayed in a position 34.

The same items of information are displayed absolutely in the same way on the display units 44 of the started-up user terminal devices (which are, i.e., the user terminal devices repeatedly executing the processes in steps S4 through S8 in FIG. 22) of all the users that remain connected to the message shared system among the twelve users registered.

Thus, as shown in FIG. 19, all the users registered, as those belonging to the same group, in the user registration information are able to see the same screen on the display units 44 of the respective user terminal devices. If the content of the message information is changed, the message information is transmitted and received by the processing operation described above between the user terminal devices 21 through 23, and this is immediately reflected on the screens of all the members.

As discussed above, the scheme according to this embodiment is that the users of the respective user terminal devices can neither determine nor change the members (users) forming the group and the user display positions (order) on the display unit 44 of the user terminal device, and only the server apparatus of the system administrator as the user of the system administrator terminal device 26 can determine and change them as the necessity may arise. This scheme, unlike the conventional instant messaging application, obviates the problems given above and enables the users belonging to the group as a community in which the members are fixed as in the working place and family to easily perform the immediate communications by the message information in a way that gives such a sense of solidarity as to see absolutely the same screen as other members do.

Further, according to the system of the present invention, pieces of the character information as one category of the message information are inputted respectively by the plurality of users and are simultaneously individually displayed in parallel on the user-by-user basis. It is therefore possible, unlike the conventional text chat application, to easily understand who chats and what the user chats about whenever participating in a chat session. Furthermore, when given a query from somebody, the atmosphere in the group is not necessarily broken even if not immediately responded thereto. Moreover, it is feasible to send, as messages in a take-it-easy manner, a fresh topic, a soliloquy and a worry that do not necessarily need receiving replies from other persons.

[Twelfth Embodiment]

Next, a twelfth embodiment will be discussed.

An architecture in the twelfth embodiment is basically the same as the eleventh embodiment has, and hence the architecture in the eleventh embodiment is diverted to the discussion on the twelfth embodiment.

In the eleventh embodiment, the message information is multicast directly to all the user terminal devices from the source user terminal device. By contrast, according to the twelfth embodiment, the message information is temporarily sent to the server apparatus 2 from the source user terminal device, and is thereafter multicast to all the user terminal devices from the server apparatus 2.

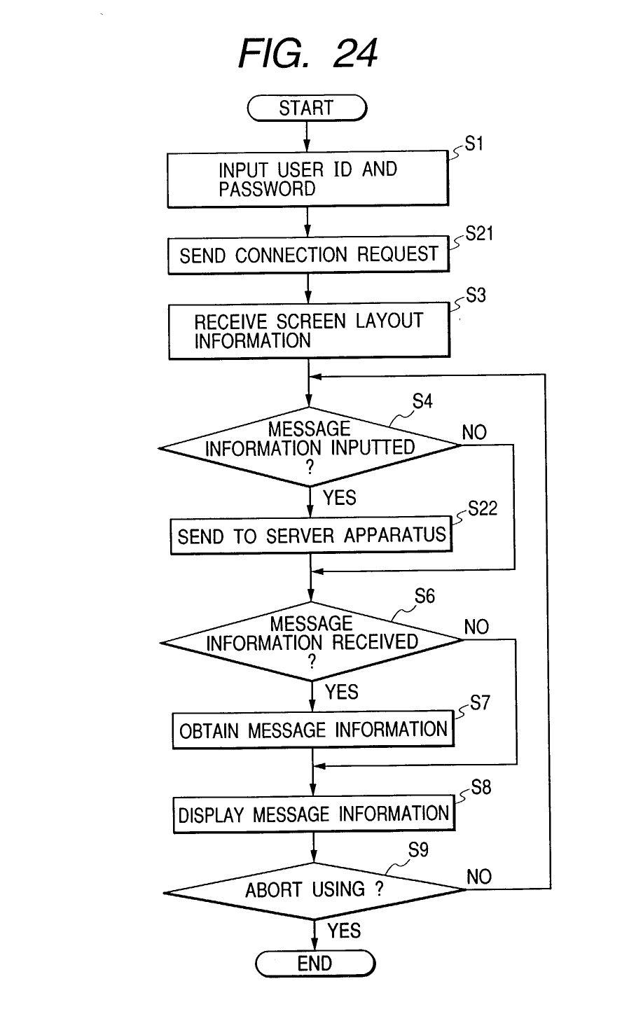

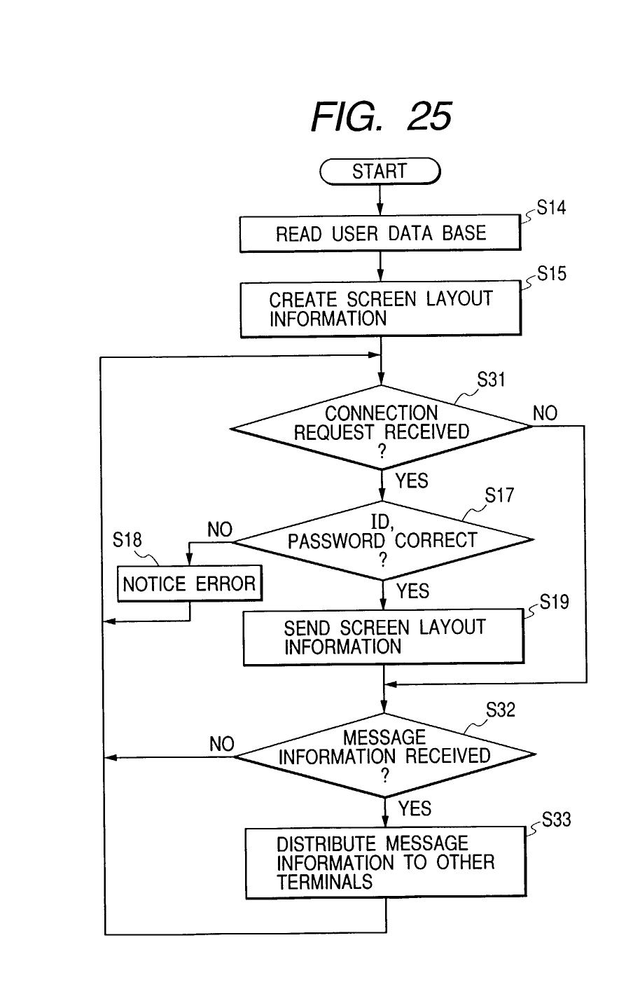

FIG. 24 is a flowchart showing operating steps of the terminal devices 21 through 23 in the twelfth embodiment. FIG. 25 is a flowchart showing operating steps of the server apparatus 25 in the twelfth embodiment. Note that the operations shown in these flowcharts are basically the same as those in the eleventh embodiment shown in FIGS. 22 and 23, and therefore the steps having the same contents are marked with the same step numerals with the repetitive explanations omitted.

According to the twelfth embodiment, the user terminal device to which the user ID and the password are inputted in step S21 shown in FIG. 24, sends to the server apparatus a connection request containing values of the user ID and the password. The server apparatus 25 receiving this connection request (YES in S31 in FIG. 25) authenticates the user by collating the user ID and the password (S17), and transmits the screen layout information to the user terminal device having sent the connection request (S19).

The user terminal device receiving the screen layout information (S3 in FIG. 24), if the message information is inputted from the input unit 42 of the user terminal device concerned (YES in S4), transmits the same message information to the server apparatus 25 (S22). On this occasion, the user ID of the user of the source user terminal device is attached to the message information.

The server apparatus 25 receiving the message information (YES in S32 in FIG. 25) multicasts the message information together with the user ID to the user terminal devices of all members (excluding the user having the user ID concerned) of the group to which the user having the user ID concerned belongs (S33). Then, the processing returns to S31.

Thus, according to the twelfth embodiment, the message information is multicast to all other user terminal devices via the server apparatus 25 from the source user terminal device, whereby the all the group members can see the same screen.

[Thirteenth Embodiment]

Note that the software program codes themselves for actualizing the functions in the respective embodiments discussed above, may configure the present invention, and a storage medium stored with the program codes may also configure the present invention.

In this case, it follows that the program codes themselves read from the storage medium actualize the functions of the respective embodiments discussed above, and that the storage medium stored with the program codes configure the present invention.

The storage medium for supplying the program codes may involve the use of, e.g., a floppy disk, a hard disk, an optical disk, a magneto-optic disk, a CD-ROM, a CD-R, a magnetic tape, a non-volatile memory card and a ROM.

Further, the present invention, as a matter of course, includes a case where the functions of the respective embodiments discussed above are actualized by executing the program codes read by the computer, and besides a case where the OS etc running on the computer executes a part or the whole of the actual processes on the basis of the instructions of the program codes, and the functions of the respective embodiments discussed above are actualized by this processing.

Moreover, the present invention, as a matter of course, includes a case where after the program codes read from the storage medium have been written to a memory provided in a function extension board inserted into the computer or in a function extension unit connected to the computer, the CPU etc provided in the function extension board or in the function extension unit, based on the instruction of the program codes, executes a part of the whole of the actual processes, and the functions in the respective embodiments discussed above are actualized by this processing.

As many apparently widely different embodiments of the present invention can be made without departing from the spirit and scope thereof, it is to be understood that the invention is not limited to the specific embodiments thereof except as defined in the claims.

What is claimed is:

1. A server apparatus connected via communication lines to information processing devices having display means and controlling a transmission and a receipt of the information between said information processing devices, said apparatus comprising:
receiving means for receiving the information from said information processing device;
layout information creating means for creating display layout information, to be displayed on said display means, of an identifier for identifying each of said information processing devices and the information corresponding to the identifier;
first transmitting means for transmitting the information to each of said information processing devices; and
second transmitting means for transmitting the layout information to each of said information processing devices.

2. A server apparatus according to claim 1, wherein said layout information creating means creates the display layout information on the basis of a receipt count of the information received by said receiving means.

3. A server apparatus according to claim 1, wherein said layout information creating means creates the display layout information on the basis of a data size of the information received by said receiving means.

4. A server apparatus according to claim 1, wherein said layout information creating means creates the display layout information on the basis of a log-in count into each of said information processing devices.

5. A server apparatus according to claim 1, wherein said layout information creating means creates the display layout information on the basis of a log-in time into each of said information processing devices.

6. A server apparatus according to claim 1, wherein said layout information creating means creates the display layout information on the basis of a using time of a user of each of said information processing devices.

7. A server apparatus according to claim 1, wherein said layout information creating means creates the display layout information on the basis of affairs result information of the user of each of said information processing devices.

8. A server apparatus according to claim 1, wherein said layout information creating means creates the display layout information on the basis of data transmitted from a system management terminal different from said server apparatus via the communication line.

9. An information processing device connected via a communication line to a server apparatus and transmitting and receiving information to and from other information processing devices via said server apparatus, said information processing device comprising:
first receiving means for receiving the information transmitted from said server apparatus;
second receiving means for receiving layout information transmitted from said server apparatus; and
display means for displaying an identifier for identifying each of said information processing devices and the information corresponding to each of said information processing devices,
wherein display positions of the identifier and the information displayed by said display means are controlled by the layout information.

10. A control method of a server apparatus connected via communication lines to information processing devices having display means and controlling a transmission and a receipt of the information between said information processing devices, said method comprising:
a receiving step of receiving the information from said information processing device;
a layout information creating step of creating display layout information, to be displayed on said display means, of an identifier for identifying each of said information processing devices and the information corresponding to the identifier;
a first transmitting step of transmitting the information to each of said information processing devices; and
a second transmitting step of transmitting the layout information to each of said information processing devices.

11. A control method of an information processing device connected via a communication line to a server apparatus and transmitting and receiving information to and from other information processing devices via said server apparatus, said method comprising:
a first receiving step of receiving the information transmitted from said server apparatus;
a second receiving step of receiving layout information transmitted from said server apparatus; and
a display step of displaying an identifier for identifying each of said information processing devices and the information corresponding to each of said information processing devices,
wherein display positions of the identifier and the information displayed by said display means are controlled by the layout information.

12. A program component for a server apparatus connected via communication lines to information processing devices having display means and controlling a transmission and a receipt of the information between said information processing devices, said program component comprising:
receiving means for receiving the information from said information processing device;
layout information creating means for creating display layout information, to be displayed on said display means, of an identifier for identifying each of said information processing devices and the information corresponding to the identifier;
first transmitting means for transmitting the information to each of said information processing devices; and
second transmitting means for transmitting the layout information to each of said information processing devices.

13. A program component for an information processing device connected via a communication line to a server apparatus and transmitting and receiving information to and from other information processing devices via said server apparatus, said program component comprising:
first receiving means for receiving the information transmitted from said server apparatus;
second receiving means for receiving layout information transmitted from said server apparatus; and
display means for displaying an identifier for identifying each of said information processing devices and the information corresponding to each of said information processing devices,
wherein display positions of the identifier and the information displayed by said display means are controlled by the layout information.
